(19) United States
(12) Patent Application Publication
(10) Pub. No.: US 2026/0024010 A1
(43) Pub. Date: Jan. 22, 2026

(54) LEARNING DEVICE, DISPLAY DEVICE, LEARNING METHOD, DISPLAY METHOD, AND RECORDING MEDIUM

(71) Applicant: NEC Corporation, Minato-ku, Tokyo (JP)

(72) Inventors: Takuya HIRAOKA, Tokyo (JP); Takashi ONISHI, Tokyo (JP)

(73) Assignee: NEC Corporation, Minato-ku, Tokyo (JP)

(21) Appl. No.: 18/872,936

(22) PCT Filed: Jun. 23, 2022
(86) PCT No.: PCT/JP2022/025100

§ 371 Date: Dec. 9, 2024

(51) Int. Cl. G06N 20/00

(52) U.S. Cl. CPC G06N 20/00

(57) ABSTRACT

A learning device includes: a model acquisition means that, through training using data that links a state of an environment where an agent performs an action, an action that is executable in the state, and a next state in a case where the action is performed in the state, acquires a model takes a state and an action as input and a next state as output; a feedback information acquisition means that, based on the acquired model, acquires feedback information that is information that is used for training the model or for training a new model that takes a state and an action as input and a next state as output; and a policy management means that trains a policy indicating an action of the agent according to a state by using the model acquired through training using the feedback information.

### TECHNICAL FIELD

The present invention relates to a learning device, a display device, a learning method, a display method, and a recording medium.

### BACKGROUND ART

There are cases where learning of control for a control target is performed offline. Here, performing offline learning means performing training using data that has been obtained in advance.

For example, Patent Document 1 describes a method of adjusting the parameters of a dynamics model by performing offline repetitive learning control using motion data obtained by making an actual robot arm trace a circular trajectory and motion data obtained by making a simulator to which a dynamics model of the robot arm is applied trace a circular motion.

### PRIOR ART DOCUMENTS

### Patent Documents

Patent Document 1: Japanese Unexamined Patent Application, First Publication No. 2020-032481

### SUMMARY OF THE INVENTION

### Problems to be Solved by the Invention

In a case of performing learning of control of a control target using obtained data obtained in advance, if there are states among the possible states of the control target for which sufficient data has not been obtained, it is possible that the accuracy of learning about control in those states will be low. It is preferable to be able to improve the accuracy of learning of control even in a state where sufficient data is not available.

An example object of the present invention is to provide a learning device, a display device, a learning method, a display method, and a recording medium that can solve the above-mentioned problems.

### Means for Solving the Problem

According to a first example aspect of the present invention, a learning device includes: a model acquisition means that, through training using data that links a state of an environment where an agent performs an action, an action that is executable in the state, and a next state in a case where the action is performed in the state, acquires a model takes a state and an action as input and a next state as output; a feedback information acquisition means that, based on the acquired model, acquires feedback information that is information that is used for training the model or for training a new model that takes a state and an action as input and a next state as output; and a policy management means that trains a policy indicating an action of the agent according to a state by using the model acquired through training using the feedback information.

According to a second example aspect of the present invention, a display device includes: a display means that displays, for each item included in information indicating a next state output by a model simulating an environment in which an agent performs an action in response to input of information indicating a state and information indicating an action, an evaluation index value of accuracy of the item in information indicating the next state. The items included in the information are also referred to as items of information.

According to a third example aspect of the present invention, a display device includes: a display means that displays, for each item included in information indicating a next state output by a model simulating an environment in which an agent performs an action in response to input of information indicating a state and information indicating an action, an evaluation index value of accuracy of the item in information indicating the next state.

According to a fourth example aspect of the present invention, a display device includes: a display means that displays an evaluation index value of accuracy of each of a plurality of time-series data of a state in an environment and an action of an agent, the plurality of time-series data being time-series data of inputs and outputs of a model simulating an environment in which the agent performs an action.

According to a fifth example aspect of the present invention, a learning method executed by a computer includes: through training using data that links a state of an environment where an agent performs an action, an action that is executable in the state, and a next state in a case where the action is performed in the state, acquiring a model takes a state and an action as input and a next state as output; based on the acquired model, acquiring feedback information that is information that is used for training the model or for training a new model that takes a state and an action as input and a next state as output; and training a policy indicating an action of the agent according to a state by using the model acquired through training using the feedback information.

According to a sixth example aspect of the present invention, a display method executed by a computer includes: displaying, for each item included in information indicating a next state output by a model simulating an environment in which an agent performs an action in response to input of information indicating a state and information indicating an action, an evaluation index value of accuracy of the item in information indicating the next state.

According to a seventh example aspect of the present invention, a display method executed by a computer includes: displaying an evaluation index value of accuracy of each of a plurality of time-series data of a state in an environment and an action of an agent, the plurality of time-series data being time-series data of inputs and outputs of a model simulating an environment in which the agent performs an action.

According to an eighth example aspect of the present invention, a recording medium stores a program for causing a computer to: through training using data that links a state of an environment where an agent performs an action, an action that is executable in the state, and a next state in a case where the action is performed in the state, acquire a model takes a state and an action as input and a next state as output; based on the acquired model, acquire feedback information that is information that is used for training the model or for training a new model that takes a state and an action as input and a next state as output; and train a policy indicating an action of the agent according to a state by using the model acquired through training using the feedback information.

According to a ninth example aspect of the present invention, a recording medium stores a program for causing a computer to: display, for each item included in information indicating a next state output by a model simulating an environment in which an agent performs an action in response to input of information indicating a state and information indicating an action, an evaluation index value of accuracy of the item in information indicating the next state.

According to a tenth example aspect of the present invention, a recording medium stores a program for causing a computer to display an evaluation index value of accuracy of each of a plurality of time-series data of a state in an environment and an action of an agent, the plurality of time-series data being time-series data of inputs and outputs of a model simulating an environment in which the agent performs an action.

### Effect of Invention

According to the present invention, in a case of performing learning of control for a control target using previously obtained data, it is expected that the accuracy of the learning of control in a state where sufficient data is not available can be improved.

### BRIEF DESCRIPTION OF THE DRAWINGS

FIG. 1 is a diagram showing an example of the configuration of a learning system according to the embodiment.

FIG. 2 is a diagram showing an example of the configuration in a case where a data collection device according to the embodiment acquires data from a control target.

FIG. 3 is a diagram showing an example of data flow regarding the data collection device according to the embodiment.

FIG. 4 is a diagram showing an example of data flow in a case where the learning device according to the embodiment trains a model of the control target and trains the policy π_{θ}.

FIG. 5 is a diagram showing an example of a processing procedure by which the learning device according to the embodiment trains a model of the control target and trains the policy π_{θ}.

FIG. 6 is a diagram showing an example of a system configuration during operation of the control target in the embodiment.

FIG. 7 is a diagram showing an example of a hopper.

FIG. 8 is a diagram showing an example of the configuration of data indicating a state in the embodiment.

FIG. 9 is a diagram showing an example of the configuration of data indicating a state in the embodiment.

FIG. 10 is a diagram showing an example of data input and output in a model and a policy in a case where the learning device of the embodiment generates a pseudo trajectory.

FIG. 11 is a diagram showing an example of a display screen showing the importance of state elements, displayed by the display portion according to the embodiment.

FIG. 12 is a diagram showing an example of a display screen showing the importance of a pseudo trajectory, displayed by the display portion according to the embodiment.

FIG. 13 is a diagram showing an example of an editing screen for the pseudo trajectory τ₁ displayed by the display portion according to the embodiment.

FIG. 14 is a diagram showing an example of an editing screen for the pseudo trajectory after correction by a user, displayed on the display portion according to the embodiment.

FIG. 15 is a diagram showing an example of a weight setting screen for elements of the pseudo trajectory ii displayed on the display portion according to the embodiment.

FIG. 16 is a diagram showing an example of an editing screen for the pseudo trajectory τ₃ displayed by the display portion according to the embodiment.

FIG. 17 is a diagram showing an example of a weight setting screen for elements of pseudo trajectory τ₃ displayed by the display portion according to the embodiment.

FIG. 18 is a diagram showing another example of the configuration of the learning device according to an embodiment.

FIG. 19 is a diagram showing an example of the configuration of a display device according to the embodiment.

FIG. 20 is a diagram showing another example configuration of the display device according to the embodiment.

FIG. 21 is a diagram showing an example of processing steps in a learning method according to the embodiment.

FIG. 22 is a diagram showing an example of processing steps in the display method according to the embodiment.

FIG. 23 is a diagram showing another example of processing steps in the display method according to the embodiment.

FIG. 24 is a schematic block diagram illustrating the configuration of a computer according to at least one embodiment.

### EXAMPLE EMBODIMENT

Hereinbelow, embodiments of the present invention shall be described, but the invention according to the claims is not limited to the following embodiments. Furthermore, not all of the combinations of features described in the embodiments may not be essential to the solutions of the invention.

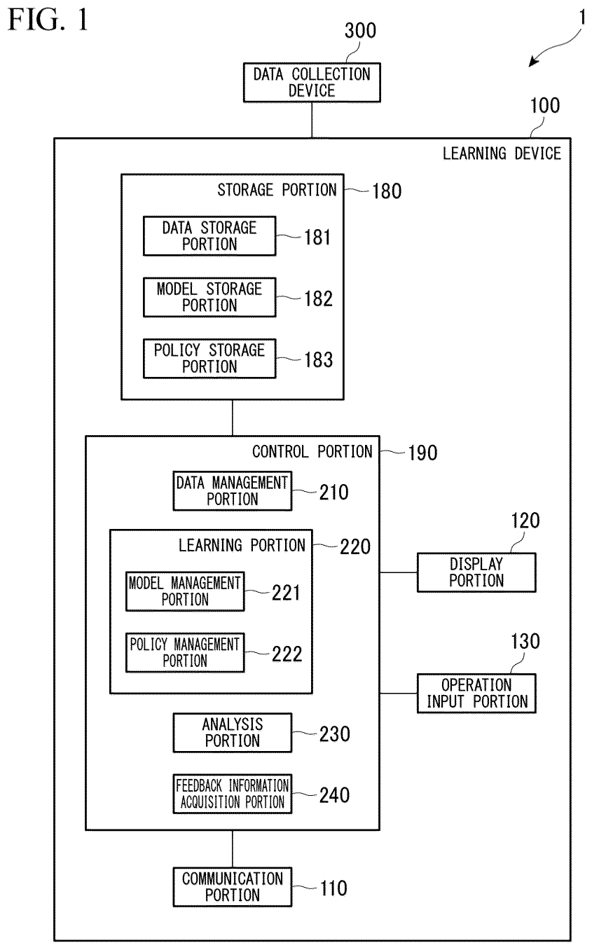

FIG. 1 is a diagram showing an example of the configuration of a learning system according to the embodiment. In the configuration shown in FIG. 1, a learning system 1 includes a data collection device 300 and a learning device 100. The learning device 100 includes a communication portion 110, a display portion 120, an operation input portion 130, a storage portion 180, and a processing portion 190. The storage portion 180 includes a data storage portion 181, a model storage portion 182, and a policy storage portion 183. The processing portion 190 includes a data management portion 210, a learning portion 220, an analysis portion 230, and a feedback information acquisition portion 240. The learning portion 220 includes a model management portion 221 and a policy management portion 222.

The learning system 1 learns a control method for a control target. Specifically, the data collection device 300 acquires data in advance from the control target. The learning device 100 acquires the model of the control target using the obtained data, and uses the acquired model to learn a control method.

The term “in advance” as used here means before the learning device 100 starts learning the control method for the control target. As will be described later in the description of “environment,” the data collection device 300 may acquire data from the operating environment of the control target, in addition to the control target. The learning device 100 may also be configured to construct a model that includes the operating environment of the control target in addition to the control target.

The control target for which the learning device 100 learns a control method is not limited to a specific one. Anything that can be controlled can be the control target. For example, the control target may be equipment such as a plant or factory or a power plant, a system such as a production line in a factory, or a single device. Alternatively, the control target may be a moving body such as an automobile, an airplane, a ship, or a self-propelled mobile robot.

The learning of a control method for a control target performed by the learning device 100 can be regarded as a type of reinforcement learning. Reinforcement learning referred to here is a machine learning technique that learns a policy, which is the action rule of an agent that performs an action in a certain environment, based on the state observed in the environment and a reward that represents an evaluation of the state or action.

In a case where a control target itself behaves according to a control rule, the control target corresponds to an example of an agent, the behavior of the control target corresponds to an example of an action, and the operating rule corresponds to an example of a policy.

For example, if the control target is a chemical plant and a control mechanism is incorporated into the chemical plant to operate automatically or semi-automatically, the chemical plant corresponds to an example of an agent, the operation of the chemical plant corresponds to an example of an action, and the operating rule for the chemical plant to operate automatically or semi-automatically corresponds to an example of a policy.

In a case where a control device that controls the control target is provided separately from the control target, the control device corresponds to an example of an agent, the control of the control target performed by the control device corresponds to an example of an action, and the control rules correspond to an example of a policy.

For example, if the control target is a chemical plant and a control device that controls the chemical plant is installed externally to the chemical plant, the control device corresponds to an example of an agent, the control of the chemical plant performed by the control device corresponds to an example of an action, and the control rule for the control device to control the chemical plant corresponds to an example of a policy.

In both cases where the control target itself operates according to control rules and where a control device that controls the control target is provided separately from the control target, the control target, or the control target and its operating environment, are examples of the environment. That is, the state of the control target may be the subject of state observation, or in addition to the state of the control target, the state of the operating environment of the control target may also be the subject of state observation. Furthermore, the reward value may be obtained by stage observation, or may be obtained by calculation or the like.

For example, in a case where the control target is a chemical plant, the chemical plant or the chemical plant and its operating environment are examples of the environment in reinforcement learning. Examples of states in reinforcement learning include the state of a chemical plant, such as the values of pressure and flow rate sensors installed in the chemical plant, or in addition to the state of the chemical plant, the state of the operating environment of the chemical plant, such as the air temperature surrounding the chemical plant.

Furthermore, a control command value for a chemical plant, such as a proportional-integral-differential (PID) control command value for the opening degree of a specified valve, corresponds to an example of an action in reinforcement learning. Also, a measurable value may be used as the reward value, for example the production amount of an end product such as ethylene or gasoline measured by a sensor. Alternatively, a sensor for measuring the production amount of the end product may not be provided, and the production amount of the end product may be calculated from the consumption amount of raw materials, or a value obtained by calculation may be used as the reward value.

The user may also be a chemical plant designer, operator, or practitioner. The model of the control target may also be a simulator used in the operation of a chemical plant. Moreover, a control rule for controlling a chemical plant is an example of a policy in reinforcement learning.

The learning device 100 uses the interaction between the simulator and the policy to construct a pseudo trajectory, which is data indicating a time series of the control over the chemical plant and the state of the chemical plant. For example, the learning device 100 can improve the accuracy of the simulator by having the user return feedback information on the generated pseudo trajectory.

Furthermore, the learning device 100 can automatically operate a chemical plant by using a policy constructed using the improved simulator. In addition, by presenting the generated pseudo trajectory to a practitioner, it is possible to assist in the creation of operation plans for chemical plants.

In the following, the control target, or the control target and the operating environment thereof, will also be referred to as the “environment” and is denoted by p. The state of the control target, or the state of the control target and the state of the operating environment of the control target, is also called a “state” and is denoted by s. The operation of a control target, or the control over a control target, is also called an “action” and is denoted by a. An operating rule that specifies the operation of a control target, or a control rule that specifies the control over the control target, is also called a “policy” and is denoted by π. The policy to be trained by the learning device 100 is denoted by π_{θ}.

The “θ” in “π_{θ}” indicates a parameter value in a model representing the policy π_{θ}. It is written as “π_{θ}” to distinguish it from the information gathering policy π_{β} described below.

The policy π_{θ} may be configured as a function that receives an input of a state s and outputs an action a. The policy π_{θ} in this case is expressed as in Expression (1).

$$[ Expression 1 ]$$

$${π}_{θ} ( a \vert s ) \qquad ( 1 )$$

In the following, time will be expressed in time steps of a fixed time Δt, and will be expressed as time step 0, time step 1, time step 2, and so on. The time Δt may be different for each time step.

A time step determined as a reference time step, such as the time step at which the control target starts to operate or the current time step T, is represented as time step 0. In a case where the current time step T is used as a reference, the time step t can also be expressed as “(current time step T)+t”.

Each one step in a time step is also referred to as each time step.

Also, state observation is assumed to be performed for each time step, and the state at time step t (t is an integer t≥0) is denoted by sₜ. State sₜ₊₁ at time step t+1 is also referred to as the next state of state sₜ at time step t.

Furthermore, the learning device 100 is assumed to train a policy π_{θ} for determining an action for each time step. An action at time step t is denoted by aₜ.

In addition, the learning device 100 acquires the value of the reward used in learning the policy π_{θ} for each time step. The reward at time step t is denoted by rₜ. The reward rₜ can be said to be a value that indicates an evaluation of the quality of the action aₜ at time step t.

In learning the policy π_{θ}, for example, the cumulative reward r₀+r₁+r₂+ . . . for each time step may be set as an objective function, and a policy π_{θ} search may be performed so as to obtain a higher evaluation indicated by this objective function. Alternatively, the objective function may be the cumulative reward r₀+αr₁+α²r₂+ . . . (where 0<α<1) obtained by adding up rewards that are discounted as time passes. In other words, the cumulative reward is a value that indicates an evaluation of the quality of the action at each time step. In this case, the higher the cumulative reward (e.g., the greater the value of the cumulative reward), the higher the quality of the action, and the lower the cumulative reward (e.g., the smaller the value of the cumulative reward), the lower the quality of the action.

The learning device 100 may use a reward in which a larger value indicates a higher evaluation. Alternatively, the learning device 100 may use a reward (i.e., a so-called loss) where a smaller value indicates a higher evaluation.

As described above, the data collection device 300 acquires data in advance from the control target.

FIG. 1 shows an example in which the data collection device 300 is configured as a device separate from the learning device 100. In this case, the data collection device 300 may be configured using a computer such as a personal computer (PC) or a workstation.

Alternatively, the data collection device 300 may be a part of the learning device 100.

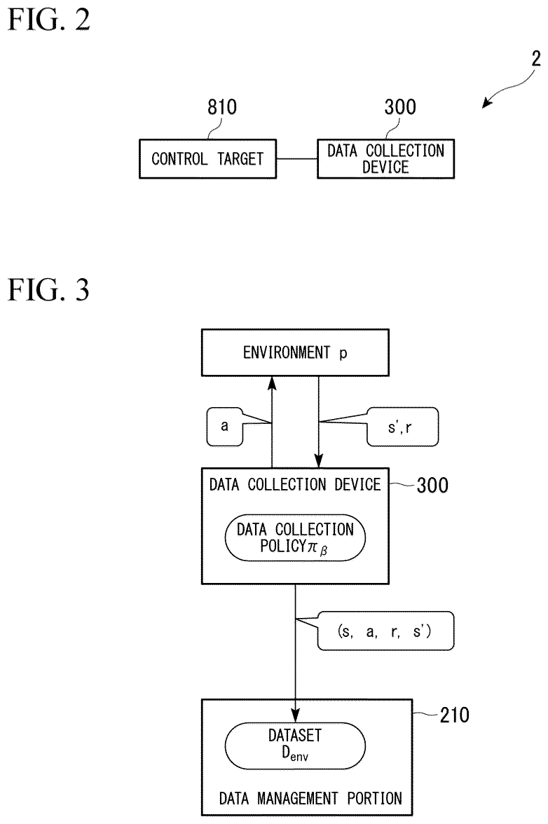

FIG. 2 is a diagram showing an example of a configuration in a case where the data collection device 300 acquires data from the control target. As shown in FIG. 2, the control target is also represented as a control target 810. The system with the configuration shown in FIG. 2 is also denoted by data collection system 2.

FIG. 2 shows an example in which the data collection device 300 transmits data to the learning device 100 after completing acquisition of data from the control target 810. In this case, the data collection device 300 does not need to be communicatively connected to the learning device 100 while acquiring the data.

Alternatively, at a time when the data collection device 300 is acquiring data from the control target 810, the data collection device 300 may also transmit the data to the learning device 100. In this case, the data collection device 300 may be communicatively connected to both the control target 810 and the learning device 100 at the same time.

FIG. 3 is a diagram showing an example of data flow in relation to the data collection device 300. In the example shown in FIG. 3, the data collection device 300 performs an action a in a case where the state of the environment p is s. s′ is the next state of the state s (i.e., the state at the next time step), and the action a causes the transition from state s to the next state s′.

Then, the data collection device 300 acquires the value of the reward r at the time step for the next state s′ and the observed value of the next state s′. The data collection device 300 may include a sensor to observe the state and obtain the observed value. Alternatively, the control target 810 as the environment p may include a sensor to observe the state, and the data collection device 300 may acquire the observed value of the state from the control target 810. Furthermore, the value indicating the state may include a value obtained by calculation.

The value indicating the state corresponds to an example of information indicating the state.

The value indicating the state is also simply called the state. For example, obtaining a value indicating a state is also referred to as obtaining a state. The reward value is also referred to simply as the reward. For example, obtaining a reward value is also referred to as obtaining a reward. The value indicating the action is also simply called the action. For example, obtaining a value indicating an action is also referred to as obtaining an action.

As described above, FIG. 3 shows an example in which the data collection device 300 performs the action a. On the other hand, the action a may be performed by an entity other than the data collection device 300.

For example, an operator may operate a chemical plant, which is an example of environment p, and the data collection device 300 may record the operations performed by the operator and the state of the chemical plant for each time step. In this case, the operation performed by the operator at each time step corresponds to an example of action a, and the state of the chemical plant at the start of the operation corresponds to an example of state s. Moreover, the state of the chemical plant after the operation is completed (specifically, the state of the chemical plant in the next time step) corresponds to an example of the next state s′.

As described above, the reward r may be obtained by observing the environment p, or the data collection device 300 or the learning device 100 may calculate the reward r.

A rule for determining an action a in a case where the data collection device 300 acquires data from a control target is called a data collection policy, and is represented by π_{β}. A data collection policy may be, for example, a function that takes an input of state s and determines an action a. The data collection policy π_{β} in this case can be expressed as “π_{β}(a|s)” as in the above Expression (1).

The data collection device 300 generates data that combines a state s, an action a, a reward r, and a next state s′ for each time step, and transmits the generated data to the learning device 100. Data that combines a state, an action, a reward, and the next state is also called a quadruple of data or a quadruple, and the four data are expressed in parentheses “( )”. For example, a quadruple of data consisting of a state s, an action a, a reward r, and a next state s′ is also represented as “(s, a, r, s′).” A quadruple of data is an example of data that links the state of the environment where an agent performs an action, the actions that can be performed in that state, a reward that represents the quality of that action, and the next state in a case where the action is performed in that state.

The data acquisition device 300 may repeat acquiring data from the control target 810 until a predetermined number of quadruples of data are obtained. In this way, the learning device 100 may acquire and store a predetermined number of quadruples of data from the data collection device 300.

In the learning device 100, the data management portion 210 stores the quadruple data transmitted by the data collection device 300 in the model storage portion 182. This set of quadruple data is also denoted as dataset Dₑₙᵥ.

The learning device 100 may calculate the reward r. In this case, the data collection device 300 transmits to the learning device 100 a triplet of data that combines a state s, an action a, and a next state s′.

The data collection device 300 may transmit data not including the next state to the learning device 100 in the form of time-series data, and the learning device 100 may insert the next state.

As described above, the learning device 100 acquires the model of the control target 810 using the data acquired from the control target 810 by the data collection device 300, and trains the control method using the acquired model. The model of the control target 810 corresponds to an example of the model of the environment p. The model of the control target 810 acquired by the learning device 100 is also referred to as a model of the environment p.

Here, it is possible that the data acquired by the data collection device 300 from the control target 810 does not provide sufficient data for a certain state and action. For example, in a case where the data collection device 300 acquires data on the actual operation of the control target 810, it is conceivable that data regarding states and actions other than states that appear during the actual operation and actions performed during the actual operation in response to those states will not be obtained.

In a case where the learning device 100 acquires a model of the control target 810 by training using this data, the accuracy of the model is likely to be low for states and actions other than those shown in the data. In a case where the learning device 100 uses this model to train a policy π_{θ} for controlling the control target 810, it is possible that learning cannot be performed with sufficient accuracy for states and actions where the model accuracy is low, and the policy π_{θ} cannot present appropriate actions.

For example, even if there is a more preferable control method than the control method currently being used in the operation of the control target 810, it is possible that the more preferable control method cannot be learned by training the policy π_{θ}. Furthermore, with regard to the state of the control target 810 in a case where the preferred control method is executed, and the control from that state, the accuracy of the model of the control target 810 may be low, making it impossible to train the policy π_{θ}.

Therefore, the learning device 100 accepts the input of information based on the user's knowledge and uses the information to train a model of the control target 810. It is expected that the accuracy of the policy π_{θ} will improve as the accuracy of the model of the control target 810 improves. Here, the user is assumed to be, for example, an expert on the control target 810.

The learning device 100 analyzes the output data of the model so that the user can input information that is effective in improving the accuracy of the model of the control target 810. Then, based on the analysis results, the learning device 100 presents to the user information indicating which items, among the items related to the information input by the user, have the greatest impact on improving the accuracy of the model.

The information that the user inputs to learning device 100 is also referred to as feedback information with respect to the information presented to the user by learning device 100, or simply as feedback information. The feedback information can be said to be information for reducing the discrepancy between the environment and the model of the environment.

The information that the learning device 100 presents to the user and the information that the user inputs to learning device 100 are not limited to a specific type of information.

For example, the learning device 100 may present to the user information indicating the accuracy in the output of the model for each of multiple items included in the state. This information can be interpreted as information indicating the importance of each item in terms of improving the accuracy of the model. For items with low accuracy in the output of the model, it is expected that updating the model to improve the accuracy of those items will result in a more accurate model.

The user refers to information indicating the accuracy of the model output for each item included in the state, and inputs, for example, a constraint equation that the model input/output must satisfy for an item with low accuracy. It is expected that the learning device 100 can obtain a more accurate model by training a model using the constraint equation that was input.

Alternatively, the learning device 100 may acquire multiple pieces of time-series data of the input and output of the model of the control target 810, and present information indicating the accuracy of each piece of time-series data to the user. Each piece of the time-series data of the input and output of the model of the control target 810 is also called a pseudo trajectory. The set of pseudo trajectories is also referred to as a data set D_{model}.

The user refers to the information indicating the accuracy of the pseudo trajectory and corrects, for example, a pseudo trajectory that has low accuracy. The corrected pseudo trajectory can be considered data that indicates the correct answer that the model should output. In a case where the learning device 100 trains a model using all of the multiple pseudo trajectories, it is expected that a more accurate model can be acquired by using the corrected pseudo trajectory rather than an uncorrected pseudo trajectory.

The information indicating the accuracy of each pseudo trajectory can be interpreted as information indicating the importance of each pseudo trajectory in terms of improving the accuracy of the model. It is expected that a more accurate model can be obtained by a user correcting a pseudo trajectory with low accuracy rather than correcting a pseudo trajectory that was originally highly accurate.

The learning device 100 may be configured using a computer such as a personal computer or a workstation.

The communication portion 110 communicates with other devices. For example, the communication portion 110 receives data obtained from the control target 810 and transmitted by the data collection device 300.

The display portion 120 has a display screen, such as a liquid crystal panel or an LED (Light Emitting Diode) panel, and displays various images. For example, the display portion 120 displays the information presented to the user by the learning device 100 described above.

The display portion 120 corresponds to an example of a display means.

The operation input portion 130 includes input devices such as a keyboard and a mouse, and receives user operations. For example, the operation input portion 130 accepts a user operation for inputting the above-mentioned feedback information.

The operation input portion 130 corresponds to an example of an input means.

The storage portion 180 stores various types of data. The storage portion 180 is configured using a storage device provided in the learning device 100.

The data storage portion 181 stores data used for training the model of the control target 810 and data used for training the policy π_{θ}. In particular, the data storage portion 181 stores a data set Dₑₙᵥ and a data set D_{model}. The data set Dₑₙᵥ and the data set D_{model} are examples of data used to train a model of the control target 810. The learning device 100 may use the dataset Dₑₙᵥ and the dataset D_{model} for training the model of the control target 810 as well as for training the policy π_{θ}.

The model storage portion 182 stores a model of the control target 810. In particular, the model storage portion 182 stores a plurality of models of the control target 810. In the following, an example will be described in which the model storage portion 182 stores two models, and these two models are represented as p\hat{ }₀ and p\hat{ }₁. However, the model storage portion 182 may store three or more models.

Both models p\hat{ }₀ and p\hat{ }₁ may be configured as a function that receives a state and an action in that state as input, and outputs the next state. If the state input to model p\hat{ }₀ is represented by s, the action by a′, and the next state output by model p\hat{ }₀ by s″₀, then model p\hat{ }₀ can be expressed as shown in Expression (2).

$$\begin{matrix}[ Expression 2 ] & \\ p {\hat{}}_{0} ( {s}_{0}^{″} \vert s , {a}^{′} ) & ( 2 )\end{matrix}$$

If the state input to model p\hat{ }₁ is represented by s, the action by a′, and the next state output by model p\hat{ }₁ by s″₁, then model p\hat{ }₁ can be expressed as shown in Expression (3).

$$\begin{matrix}[ Expression 3 ] & \\ p {\hat{}}_{1} ( {s}_{1}^{″} \vert s , {a}^{′} ) & ( 3 )\end{matrix}$$

The multiple models stored in the model storage portion 182 can be used to evaluate the accuracy of the model output. If the same state and action are input to multiple models and the outputs of the multiple models are similar, then the accuracy of those models for that input can be assessed as relatively high. On the other hand, if the same state and action are input to multiple models and there is a large variance in the outputs of the multiple models, the accuracy of these models for this input can be evaluated as being relatively low.

As an index showing the magnitude of variation in the outputs of a plurality of models, for example, the variance of the outputs of these plurality of models can be used.

For example, the next state s″₀ output by model p\hat{ }₀ and the next state s″₁ output by model p\hat{ }₁ are collectively referred to as the next state s″, and the variance between the next state s″₀ and the next state s″₁ is represented as Var(s″). The variance Var(s″) is expressed as in Expression (4).

$$\begin{matrix}[ Expression 4 ] & \\ Var ( {s}^{″} ) = \frac{1}{2} {\sum }_{i = 0}^{1} {( {s}_{i}^{″} - {s}_{avg}^{″} )}^{2} & ( 4 )\end{matrix}$$

s″_{avg} represents the average of next state s″₀ and next state s″₁.

The learning device 100 may train the policy π_{θ} using a reward that reflects this variance Var(s″). For example, the learning device 100 may train the policy π_{θ} using the reward r″ shown in Expression (5).

$$\begin{matrix}[ Expression 5 ] & \\ {r}^{″} = r ( s , {a}^{′} ) - Var ( {s}^{″} ) & ( 5 )\end{matrix}$$

“r(s, a′)” represents the reward before the variance Var(s″) is reflected. The reward r(s, a′) represents the evaluation of taking action a′ in state s from the perspective of the agent's operational goal.

According to the reward r″, if the accuracy of the models p\hat{ }₀ and p\hat{ }₁ for the next state s″ due to the action a′ output by the policy π_{θ} is low, the evaluation indicated by the reward r″ will be low. By training the policy π_{θ} using reward r″ instead of reward r(s, a′), the learning device 100 is expected to obtain a policy π_{θ} with a relatively small possibility of outputting an action a′ that transitions to a next state with low accuracy in the models p\hat{ }₀ and p\hat{ }₁. From this viewpoint, it is expected that the degree to which the accuracy of the policy π₀ decreases due to the accuracy of the models p\hat{ }₀ and p\hat{ }₁ can be reduced.

On the other hand, if the action a′ output by the policy π_{θ} is limited to an action a′ that transitions to a next state with low accuracy in models p\hat{ }₀ and p\hat{ }₁, as described above, it is possible that the policy π_{θ} may not be able to present an appropriate action.

Therefore, as described above, the learning device 100 presents the user with information indicating which items, among the items related to the information input by the user, have a large impact on improving the accuracy of the model, and accepts input of feedback information by the user.

The policy storage portion 183 stores the policy π_{θ}.

The processing portion 190 controls each unit of the learning device 100 to perform various processes. The functions of the processing portion 190 are performed, for example, by a CPU (Central Processing Unit) included in the learning device 100 reading and executing a program from the storage portion 180.

The data management portion 210 manages the data stored in the data storage portion 181. For example, the data management portion 210 stores the quadruple data that the communication portion 110 receives from the data collection device 300 in the data set Dₑₙᵥ stored by the data storage portion 181.

In addition, the data management portion 210 stores the quadruple data generated using the model of the control target 810 and the policy Ro in the data set D_{model} stored by the data storage portion 181.

In a case where the learning device 100 acquires a plurality of simulated trajectories as described above, the data management portion 210 stores the simulated trajectories in the data set D_{model}.

After the learning device 100 uses the feedback information to obtain a more accurate model of the control target 810 and generates quadruple data using the model, the data management portion 210 stores the generated quadruple data in the storage portion 180. The data management portion 210 may overwrite the already obtained data set D_{model} with newly obtained data. Alternatively, the data management portion 210 may leave the data set D_{model} that has already been obtained and store newly obtained data in the storage portion 180. The data management portion 210 may add newly obtained data to the data set D_{model}, or may generate a data set separate from the data set D_{model}.

The learning portion 220 trains a model of the control target 810 and trains the policy π_{θ}. In addition, the learning portion 220 generates quadruple data using the model and the policy π_{θ} of the control target 810.

The model management portion 221 trains the model of the control target 810. Specifically, the model management portion 221 uses the dataset Dₑₙᵥ to train a model p\hat{ }₀ and a model p\hat{ }₁.

Furthermore, in a case where the user inputs feedback information using the operation input portion 130, the model management portion 221 re-trains the model p\hat{ }₀ and the model p\hat{ }₁ by incorporating the obtained feedback information.

The model management portion 221 may perform training of these models so as to update the already acquired models p\hat{ }₀ and p\hat{ }₁. Alternatively, the model management portion 221 may restart the training of the model p\hat{ }₀ and the model p\hat{ }₁ from the beginning without using the already acquired models p\hat{ }₀ and p\hat{ }₁.

In other words, the model management portion 221 may use the feedback information to perform further training of an already acquired model. Alternatively, the model management portion 221 may train a new model using feedback information.

The model management portion 221 corresponds to an example of a model acquisition means.

The policy management portion 222 trains the policy π_{θ}. In particular, the policy management portion 222 performs training of the policy π_{θ} using quadruple data indicating input/output data of the model obtained by training that reflects the feedback information. This allows the policy management portion 222 to reflect in the policy π_{θ} states and actions for which sufficient data could not be obtained from the dataset Dₑₙᵥ alone, and in this respect it is expected that a more accurate policy π_{θ} can be obtained.

The policy management portion 222 corresponds to an example of a policy management means.

The analysis portion 230 generates information indicating which of the above-mentioned items related to the information input by the user has the greatest impact on improving the accuracy of the model.

For example, as described above for the learning device 100, the analysis portion 230 may calculate, for each item included in the information indicating the state, an evaluation index value for the accuracy of that item in the next state output by models p\hat{ }₀ and p\hat{ }₁, respectively. For example, the analysis portion 230 may calculate, for each item included in the information indicating the state, the variance between the value of that item in the output of model p\hat{ }₀ and the value of that item in the output of model p\hat{ }₁ as an evaluation index value for the accuracy of that item.

In this case, the items included in the information indicating the state correspond to examples of items related to information input by the user.

Furthermore, as described above with respect to the learning device 100, the analysis portion 230 may calculate an evaluation index value for the accuracy of each of the multiple pseudo trajectories. For example, the analysis portion 230 may calculate the next state according to the model p\hat{ }₀ and the next state according to the model p\hat{ }₁ for each time step in the simulated trajectory. The analysis portion 230 may then calculate the total or average value of the variance of the next state for each time step for all time steps in one simulated trajectory as an evaluation index value for the accuracy of the simulated trajectory.

In this case, the pseudo trajectory corresponds to an example of an item related to information input by the user.

The analysis portion 230 corresponds to an example of an analysis means.

The feedback information acquisition portion 240 acquires the feedback information. Specifically, the feedback information acquisition portion 240 reads feedback information input by the user using the learning device 100.

As described above, the analysis portion 230 analyzes the output of the model of the control target 810 and presents the analysis results to the user, and the feedback information acquisition portion 240 acquires the feedback information input by the user with reference to the analysis results. In this respect, it can be said that the feedback information acquisition portion 240 acquires feedback information based on the output of the model of the control target 810. In a case where the analysis portion 230 presents the analysis result to the user, the feedback information acquisition portion 240 may prompt the input of feedback information to the outside (for example, prompt the user).

The feedback information acquisition portion 240 corresponds to an example of a feedback acquisition means.

As described above for the learning device 100, the feedback information acquisition portion 240 may acquire feedback information indicating constraint conditions that the input data and output data of the model of the control target 810 should satisfy in order to improve the accuracy of the model. In particular, the feedback information acquisition portion 240 may acquire feedback information indicating constraint conditions related to items that are included in the next state output by the model of the control target 810 and that have a relatively low accuracy evaluation.

In this case, an item with a relatively low accuracy evaluation may be, for example, an item with a rating lower than the average (or median) of the ratings for multiple items including that item. Alternatively, an item with a relatively low accuracy evaluation may be an item among a portion of items selected from the plurality of items and having the lowest evaluation among the selected portion of items. Alternatively, an items with a relatively low accuracy evaluation may be an item that meets a predetermined criterion. The “predetermined criterion” in this case refers to the standard for determining whether an evaluation is low. For example, the “predetermined criterion” may be that the evaluation is below a threshold value.

The user refers to the evaluation index values for each item included in the state displayed on the display portion 120 and inputs feedback information using the operation input portion 130. In this respect, it can be said that the feedback information acquisition portion 240 acquires the feedback information input by user operation accepted by the operation input portion 130 after the display portion 120 starts displaying the evaluation index value of each item included in the state.

Furthermore, as described above with respect to the learning device 100, the feedback information acquisition portion 240 may acquire feedback information indicating a correction to the pseudo trajectory. In particular, the feedback information acquisition portion 240 may acquire feedback information indicating corrections to pseudo trajectories whose accuracy is evaluated as being relatively low.

The user refers to the evaluation index value for each simulated trajectory displayed on the display portion 120 and inputs feedback information using the operation input portion 130. In this respect, it can be said that the feedback information acquisition portion 240 acquires feedback information input by user operation received by the operation input portion 130 after the display portion 120 starts displaying the evaluation index value for each pseudo trajectory.

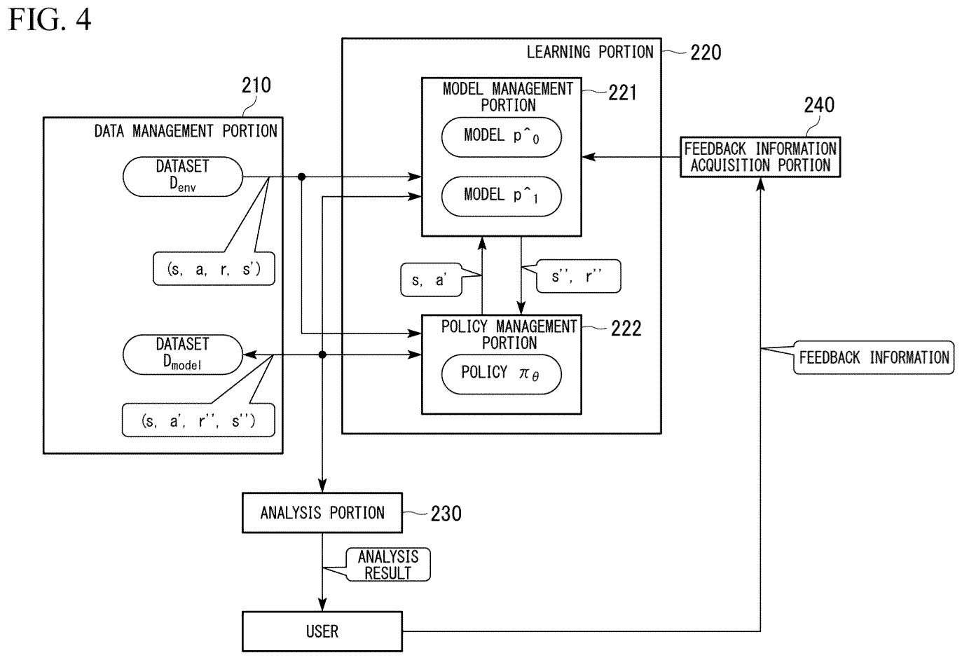

FIG. 4 is a diagram showing an example of the flow of data in a case where the learning device 100 trains a model of the control target 810 and trains the policy π_{θ}.

In the example shown in FIG. 4, the data management portion 210 reads out a quadruple of data (s, a, r, s′) from the data set Dₑₙᵥ, and outputs it to the model management portion 221 and the policy management portion 222. The model management portion 221 uses this quadruple of data to train the model p\hat{ }₀ and the model p\hat{ }₁. The policy management portion 222 uses this quadruple of data to train the policy π_{θ}. The method of training the policy π_{θ} here is not limited to a specific learning method as long as it is possible to obtain a policy π_{θ} for generating the data set D_{model}. For example, the policy management portion 222 may train the policy π_{θ} using a known offline reinforcement learning method.

After training using the dataset De, is completed, the data management portion 210 acquires the quadruple (s, a′, r″, s″) by the models p\hat{ }₀ and p\hat{ }₁ and the policy π_{θ}, and stores it in the dataset D_{model}.

Specifically, the policy management portion 222 inputs a certain state s into the policy ire to obtain an action a′, and outputs the state s and the action a′ to the model management portion 221.

The state s that the policy management portion 222 inputs to the policy ire is not limited to a specific one. For example, the data management portion 210 may read the state s from one of the quadruples of data included in the data set Dₑₙᵥ and output it to the policy management portion 222. Alternatively, the policy management portion 222 may arbitrarily generate the state s within the range of actions that the control target 810 can perform. In a case where the learning device 100 uses a pseudo trajectory, the policy management portion 222 uses the next state s″ output by the model management portion 221 as the state s in the next time step.

The model management portion 221 inputs the state s and the action a′ into the model p\hat{ }₀ to obtain the next state s″₀. In addition, the model management portion 221 inputs the state s and the action a′ into the model p\hat{ }₁ to obtain the next state s″₁. Then, the model management portion 221 outputs the next state s“and the reward r” to the policy management portion 222.

The next state s″ may be any state obtained from the next state s″₀ and the next state s″₁, and is not limited to a specific one. For example, the model management portion 221 may select the next state s″₀ as the next state s″. Alternatively, the model management portion 221 may select the next state s″₁ as the next state s″. Alternatively, the model management portion 221 may calculate the average of the next state s″₀ and the next state s″₁ and use the average as the next state s″.

As described above, the analysis portion 230 calculates the variance between the next states s″₀ and s″₁, or the variance for each item of these states. For this purpose, the learning portion 220 may link the next states s″₀ and s″₁ to the quadruple data (s, a′, r″, s″).

Alternatively, as shown in the above Expression (5), the model management portion 221 calculates the variance Var(s″) between the next states s″₀ and s″₁ in a case where calculating the reward r″. The learning portion 220 may link the variance Var(s″) to the quadruple of data (s, a′, r″, s″) instead of the next states s″₀ and s″₁. Note that the reward r″ may be calculated by a portion other than the model management portion 221. For example, the policy management portion 222 may calculate the reward r″.

Alternatively, the learning portion 220 may include a pair of next states s″₀ and s″₁ in the quadruple of data instead of the next state s″. In this case, in a case where the next state is required, each portion of the learning device 100 obtains the next state according to a predetermined method for obtaining the next state from next states s″₀ and s″₁, for example by selecting next state s″₀.

After a predetermined amount of quadruple data has been accumulated in D_{model}, the analysis portion 230 performs an analysis of the output of the model of the control target 810. As a result of the analysis, the analysis portion 230 generates information indicating which of the items related to the information input by the user have the greatest impact on improving the accuracy of the model. The analysis portion 230 then displays the obtained analysis results on the display portion 120 to present them to the user.

The user generates feedback information by referring to the analysis results by the analysis portion 230. The user operates the operation input portion 130 to input the feedback information.

The feedback information acquisition portion 240 reads the feedback information from a signal output by the operation input portion 130 in response to the user operation, and outputs the feedback information to the model management portion 221.

The model management portion 221 uses the obtained feedback information to train the models p\hat{ }₀ and p\hat{ }₁. As described above, the model management portion 221 may update the already acquired models p\hat{ }₀ and p\hat{ }₁, or may perform training from the beginning without using the already obtained models p\hat{ }₀ and p\hat{ }₁.

The policy management portion 222 trains the policy π_{θ} using the newly acquired models p\hat{ }₀ and p\hat{ }₁. The policy management portion 222 may update the policy π_{θ} that has already been obtained, or may perform training from the beginning without using the policy π_{θ} that has already been obtained.

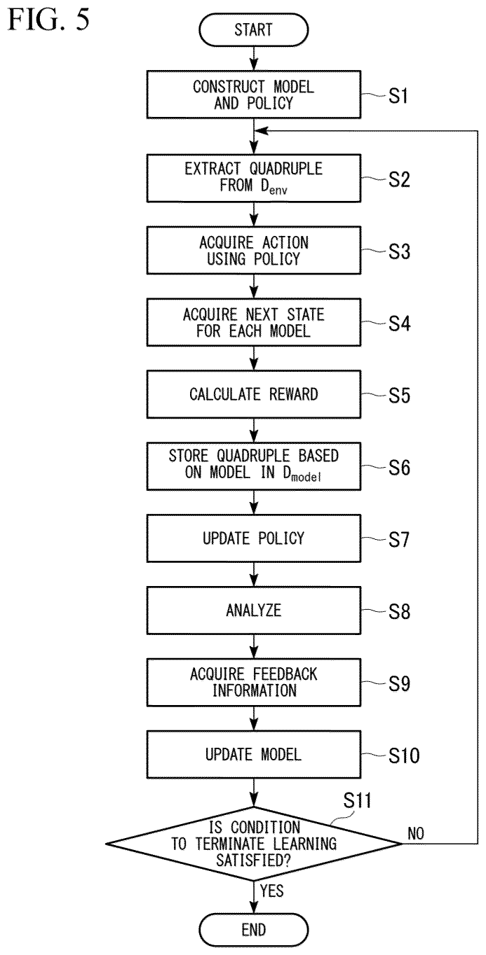

FIG. 5 is a diagram illustrating an example of a processing procedure in which the learning device 100 trains a model of the control target 810 and trains the policy π_{θ}.

### (Step S1)

The model management portion 221 constructs models p\hat{ }₀ and p\hat{ }₁ based on the dataset Dₑₙᵥ. Specifically, the model management portion 221 searches for models p\hat{ }₀ and p\hat{ }₁ that receive input of state s and action a and output next state s′ based on the quadruple data (s, a, r, s′) contained in the dataset Dₑₙᵥ. To search for the models p\hat{ }₀ and p\hat{ }₁, for example, a known supervised learning method can be used.

The fact that the model p\hat{ }₀ or p\hat{ }₁ receives an input of state s and action a and outputs the next state s′ is also referred to as estimating the next state s′ from state s and action a.

In addition, the policy management portion 222 constructs a policy π_{θ} based on the data set Dₑₙᵥ. As described above, the method of training the policy π_{θ} here is not limited to a specific learning method as long as it is possible to obtain a policy Ro for generating the data set D_{model}.

After Step S1, the process proceeds to Step S2.

### (Step S2)

The data management portion 210 randomly extracts a quadruple of data (s, a, r, s′) from the dataset Dₑₙᵥ. The data management portion 210 outputs the extracted quadruple of data to the policy management portion 222.

After Step S2, the process proceeds to Step S3.

### (Step S3)

The policy management portion 222 inputs the state s included in the quadruple of data (s, a, r, s′) extracted in Step S2 to the policy π_{θ} to obtain the action a′. Note that the obtained action a′ may be different from the action a included in the quadruple of data.

After Step S3, the process proceeds to Step S4.

### (Step S4)

The model management portion 221 inputs the state s and action a′ in Step S3 to the model p\hat{ }₀ to obtain the next state s″₀. In addition, the model management portion 221 inputs the state s and action a′ in Step S3 to the model p\hat{ }₁ to obtain the next state s″₁.

### (Step S5)

The model management portion 221 calculates the reward r″ based on the above Expression (5).

After Step S5, the process proceeds to Step S6.

### (Step S6)

The data management portion 210 stores the state s, the action a′, the reward r″, and the next state s″ in the form of a quadruple (s, a′, r″, s″) in the dataset D_{model}.

After Step S6, the process proceeds to Step S7.

In a case where the learning device 100 handles a pseudo trajectory, the learning portion 220 may set the next state s″ as a new state s and repeat the processes from steps S3 to S6. In this case, the learning portion 220 repeats the processes of steps S3 to S6 the number of times equal to the number of time steps in the pseudo trajectory, and then the process proceeds to Step S7.

### (Step S7)

The learning portion 220 updates the policy π_{θ} using the data sets D_{model} and Dₑₙᵥ. To update the policy π_{θ}, for example, a known reinforcement learning technique can be used.

After Step S7, the process proceeds to Step S8.

### (Step S8)

The analysis portion 230 performs an analysis to efficiently improve the models p\hat{ }₀ and p\hat{ }₁. For example, as described above, the analysis portion 230 may calculate, for each item included in a state, the variance between the value of that item in the next state s″₀ and the value of that item in the next state s″₁. Alternatively, the analysis portion 230 may calculate the variance between the next states s″₀ and s″₁ for each time step in the pseudo trajectory, as described above, and sum up the variances calculated for each time step for all time steps in the pseudo trajectory.

After Step S8, the process proceeds to Step S9.

### (Step S9)

The display portion 120 displays the results of the analysis by the analysis portion 230. Then, the feedback information acquisition portion 240 acquires feedback information based on the user operation received by the operation input portion 130. As mentioned above, the user is, for example, an expert on the control target 810.

After Step S9, the process proceeds to Step S10.

### (Step S10)

The model management portion 221 updates the models p\hat{ }₀ and p\hat{ }₁ based on the data sets Dₑₙᵥ and D_{model} and the feedback information.

For example, in a case where a constraint equation regarding an item included in a state is input as feedback information, the model management portion 221 trains the parameter values of model p\hat{ }₀ for each of the quadruple data included in dataset Dₑₙᵥ and the quadruple data included in dataset D_{model} so that model p\hat{ }₀ outputs the next state s″ for the input of state s and action a included in the quadruple data and so as to satisfy the constraint equation indicated in the feedback information. The model management portion 221 similarly trains the parameter values for the model p\hat{ }₁.

For example, a known constrained supervised learning method can be used to train the parameter values of the models p\hat{ }₀ and p\hat{ }₁.

After Step S10, the process proceeds to Step S11.

### (Step S11)

The learning portion 220 determines whether a preset condition for terminating the update of the models p\hat{ }₀ and p\hat{ }₁ is satisfied.

The termination condition for updating the models p\hat{ }₀ and p\hat{ }₁ is not limited to a particular method. For example, the condition for terminating the update of models p\hat{ }₀ and p\hat{ }₁ may be whether or not the processes of steps S2 to S11 in FIG. 4 have been repeated a predetermined number of times.

Alternatively, the condition for terminating the update of models p\hat{ }₀ and p\hat{ }₁ may be whether or not the accuracy of models p\hat{ }₀ and p\hat{ }₁ is evaluated to be higher than or equal to a predetermined evaluation.

Alternatively, the condition for terminating the update of the models p\hat{ }₀ and p\hat{ }₁ may be whether or not the evaluation of the policy π_{θ} is higher than or equal to a predetermined evaluation.

If the learning portion 220 determines that the termination condition is not satisfied (Step S11: NO), the process returns to Step S2.

On the other hand, if the learning portion 220 determines in Step S11 that the termination condition is met (Step S11: YES), the learning device 100 terminates the process in FIG. 5.

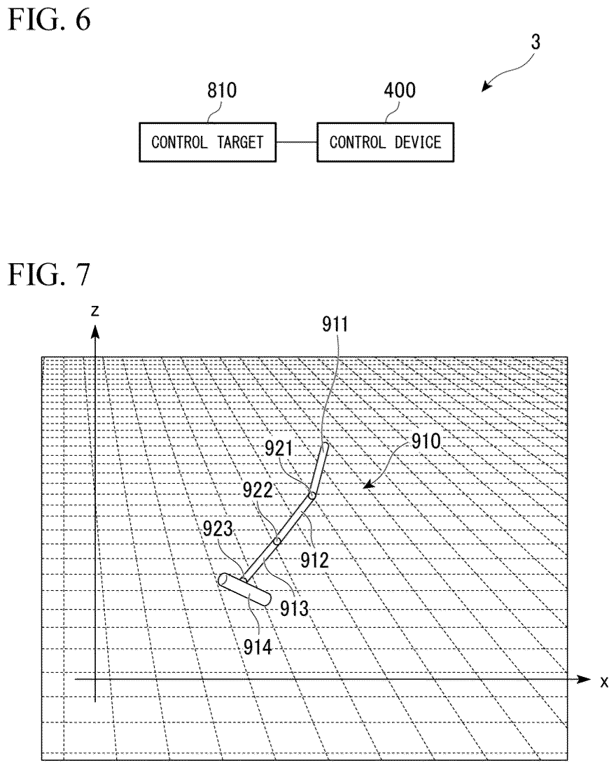

FIG. 6 is a diagram showing an example of a system configuration at a time when the control target 810 is in operation. The system shown in FIG. 6 is also denoted as control system 3.

In the configuration shown in FIG. 6, the control device 400 controls the control target 810 using the policy π_{θ} that has been trained by the learning device 100. The learning device 100 may function as the control device 400. Alternatively, the control device 400 may be provided separately from the learning device 100, and the control device 400 may store the policy π_{θ} that has been trained by the learning device 100.

Next, the process performed by the learning device 100 will be described using an example of training a policy for controlling a hopper.

FIG. 7 is a diagram showing an example of a hopper. In the example shown in FIG. 7, the hopper 910 includes a head portion 911, a thigh portion 912, a leg portion 913, and a foot portion 914. The connection portions of these parts are configured as joints whose angles are adjustable, and each joint is provided with a rotor for adjusting the angle.

A rotor 921 adjusts the angle between the head portion 911 and the thigh portion 912. The rotor 921 is also referred to as the thigh rotor 921.

A rotor 922 adjusts the angle between the thigh portion 912 and the leg portion 913. The rotor 922 is also referred to as the leg rotor 922.

A rotor 923 adjusts the angle between the leg portion 913 and the foot portion 914. The rotor 923 is also referred to as the foot rotor 923.

The hopper 910 is a mobile robot that obtains thrust by changing its posture due to the movement of each rotor. The hopper 910 needs to be moved without tipping over.

As shown in FIG. 7, the x-axis is set on the plane along which the hopper 910 moves, and the z-axis is set perpendicular to this plane. The plane on which the hopper 910 moves is also referred to as the movement plane.

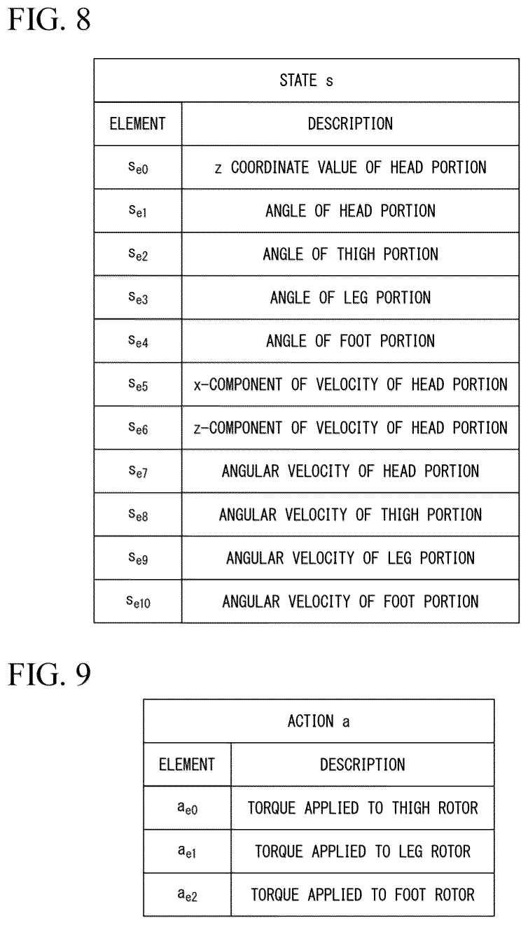

FIG. 8 is a diagram showing an example of the structure of data indicating the state s.

In the example shown in FIG. 8, the state s is represented by an 11-dimensional numerical vector. The elements of state s are denoted as elements sₑ₀, sₑ₁, . . . , sₑ₁₀. Each of these elements is an example of an item contained in a state. However, the number of elements of state s is not limited to a specific number.

Element sₑ₀ indicates the z coordinate value of the head portion 911, that is, the height of the head portion 911.

Element sₑ₁ indicates the angle of the head portion 911 relative to the plane of motion.

Element sₑ₂ indicates the angle of the thigh portion 912 relative to the plane of motion.

Element sₑ₃ indicates the angle of the leg portion 913 relative to the plane of motion.

Element sₑ₄ indicates the angle of the foot portion 914 relative to the plane of motion.

Element sₑ₅ indicates the x-component of the velocity of the head portion 911.

Element sₑ₆ indicates the z-component of the velocity of the head portion 911.

Element sₑ₇ indicates the angular velocity of the head portion 911 relative to the plane of motion.

Element sₑ₈ indicates the angular velocity of the thigh portion 912 relative to the plane of motion.

Element sₑ₉ indicates the angular velocity of the leg portion 913 relative to the plane of motion.

Element sₑ₁₀ indicates the angular velocity of the foot portion 914 relative to the plane of motion.

FIG. 9 is a diagram showing an example of the structure of data indicating action a.

In the example shown in FIG. 9, the action a is represented by a three-dimensional numerical vector. The elements of action a are denoted as elements aₑ₀, aₑ₁, and aₑ₂. However, the number of elements of the action a is not limited to a specific number.

The element aₑ₀ represents the torque applied to the thigh rotor 921.

The element aₑ₁ represents the torque applied to the leg rotor 922.

The element aₑ₂ represents the torque applied to the foot rotor 923.

In addition, the above Expression (5) will be used as the equation for calculating the reward r″, and the value of the “r(s, a′)” part of Expression (5) will be calculated based on Expression (6).

$$\begin{matrix}[ Expression 6 ] & \\ r ( s , {a}^{′} ) = {s}_{e 5} - \vert {a}_{e 0} \vert - \vert {a}_{e 1} \vert - \vert {a}_{e 2} \vert & ( 6 )\end{matrix}$$

The right-hand side of Expression (6), “sₑ₅−|aₑ₀|−|aₑ₁|−|aₑ₂|”, represents the difference obtained by subtracting the sum of the magnitudes of the torque applied to the thigh rotor, the leg rotor, and the foot rotor from the speed of the head portion 911 of the hopper 910 in the x-coordinate. It can be said that Expression (6) indicates that the faster the speed at which hopper 910 moves in the positive direction of the x coordinate, the higher the evaluation, and that the smaller the total power consumption to operate the rotor, the higher the evaluation.

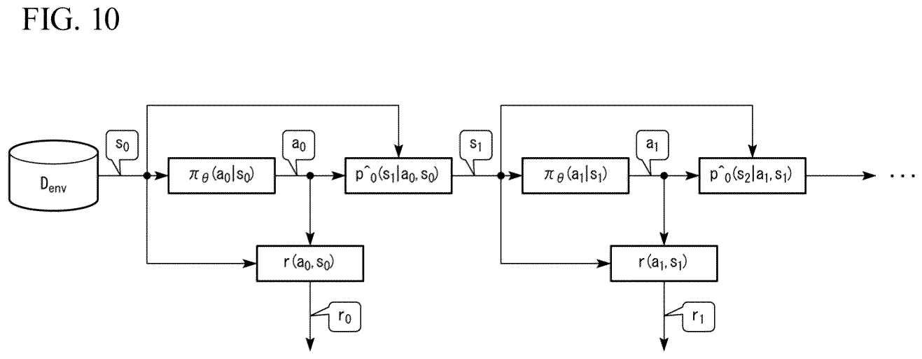

FIG. 10 is a diagram showing an example of input and output of data in the model p\hat{ }₀ and the policy π_{θ} in a case where the learning device 100 generates a pseudo trajectory.

In the example of FIG. 10, the data set Dₑₙᵥ stores a plurality of quadruple time series data obtained by operating the hopper 910. This set of quadruple time series data is called a trajectory.

The state of the hopper 910 at time step t (t is an integer t≥0) is denoted as sₜ. Time step 0 is the time when the hopper 910 starts to operate, and the initial state of the hopper 910 is represented as so. Furthermore, the action of the hopper 910 at time step t is represented by aₜ, and the reward r aₜ time step t is represented by rₜ.

The data management portion 210 reads out the initial state so of the hopper 910 in the trajectory from the data set Dₑₙᵥ and outputs it to the policy management portion 222 and the model management portion 221.

The policy management portion 222 inputs the initial state so to the policy π_{θ} to obtain an action a₀, and outputs the obtained action a₀ to the model management portion 221.

The model management portion 221 inputs the state s₀ and the action a₀ into the model p\hat{ }₀ to obtain the action s₁. FIG. 10 shows an example in which the state output by the model p\hat{ }₀ is used as the next state, and the model management portion 221 outputs the obtained state s₁ to the policy management portion 222.

The policy management portion 222 inputs the state s₁ to the policy π_{θ} to obtain an action a₁, and outputs the obtained action a₁ to the model management portion 221.

In this way, for time step t, the policy management portion 222 inputs the state sₜ to the policy π_{θ} to obtain an action aₜ, and outputs the obtained action aₜ to the model management portion 221. The model management portion 221 inputs the state sₜ and the action aₜ to the model p\hat{ }₀ to obtain the state sₜ₊₁, and outputs the obtained state sₜ₊₁ to the policy management portion 222.

The policy management portion 222 and the model management portion 221 repeat the acquisition of the action aₜ and the state sₜ+1 until a predetermined end condition is met, for example, the hopper 910 reaches the destination or falls over.

Furthermore, the model management portion 221 inputs to the model p\hat{ }₁ the same state sₜ and action aₜ as the state sₜ and action aₜ input to model p\hat{ }₀ for each time step, and also obtains the action sₜ₊₁ in the case by model p\hat{ }₁.

In addition, the learning portion 220 inputs the state sₜ and the action aₜ to the reward function shown in Expression (6) for each time step to obtain the reward rₜ. The learning portion 220 inputs the reward rₜ and the state sₜ₊₁ by the models p\hat{ }₀ and p\hat{ }₁ into Expression (5) to obtain the reward r″ₜ at time step t.

The learning portion 220 outputs the quadruple data (sₜ, aₜ, r″ₜ, sₜ₊₁) to the data management portion 210. The data management portion 210 accumulates the quadruple data output by the learning portion 220 as time-series data to generate a pseudo trajectory.

The content of the analysis by the analysis portion 230 and the information input by the user as feedback information are not limited to a specific one, and can be various depending on, for example, the control on the control target. In the following,
(1) the case where the analysis results indicate the accuracy of each element included in the state predicted by the model, and the feedback information indicates a constraint equation regarding the input and output of the model; and
(2) the case where the analysis result indicates the accuracy of each of a plurality of pseudo trajectories, and the feedback information indicates a correction value of the pseudo trajectory or information on whether the value indicated in the pseudo trajectory is correct,
will be explained using an example.
(1) The case where the analysis results indicate the accuracy of each element included in the state predicted by the model, and the feedback information indicates a constraint equation regarding the input and output of the model

In Step S8 of FIG. 5, the analysis portion 230 calculates, for each element of the state, the accuracy of that element in the output of the model based on Expression (7). The accuracy of an element in the output of a model is also called the importance of that element.

$$\begin{matrix}[ Expression 7 ] & \\ I ( {s}_{e \_ i} ) = \vert {\sum }_{t = 0}^{∞} Var ( p {\hat{}}_{0} ( {s}_{t + 1 , e \_ i} \vert {a}_{t} , {s}_{t} ) , p {\hat{}}_{1} ( {s}_{t + 1 , e \_ i} \vert {a}_{t} , {s}_{t} ) ) \vert & ( 7 )\end{matrix}$$

Let i=0, 1, . . . , 10, and elements sₑ₀, sₑ₁, . . . , sₑ₁₀ of state s are denoted as s_{e_i}. Also, s_{t+1, e_i} indicates the importance of element s_{e_i} at time step t+1.

I(s_{e_i}) indicates the importance of element s_{e_i}. Based on Expression (7), the analysis portion 230 calculates, for each time step, the variance between element s_{e_i} in the next state output by model p\hat{ }₀ and element s_{e_i} in the next state output by model p\hat{ }₁, and sums the variances for all time steps in the pseudo trajectory to obtain the importance I(s_{e_i}).

The importance I(s_{e_i}) corresponds to an example of an evaluation index value of the accuracy of the element s_{e_i} in the next state output by the model p\hat{ }₀.

Expression (7) can be interpreted as indicating that, among the elements of the state predicted by the model, the more ambiguous the element, the more important it is. Among the elements of the state predicted by the model, ambiguous elements can be said to be elements for which the model has low prediction accuracy.

In addition, ∞ in Σ in Expression (7) indicates that the number of time steps in the pseudo trajectory is arbitrary. The analysis portion 230 sums up the variances for each time step up to the last time step in the simulated trajectory.

In a case where there are multiple pseudo trajectories, the analysis portion 230 may further calculate the sum of the importance I(s_{e_i}) shown in Expression (7) for all the pseudo trajectories.

Alternatively, the analysis portion 230 may calculate, for each element of the state, the importance of that element in the model output based on Expression (8) instead of Expression (7).

$$\begin{matrix}[ Expression 8 ] & \\ I ( {s}_{e \_ i} ) = \vert {\sum }_{t = 0}^{∞} Var ( p {\hat{}}_{0} ( {s}_{t + 1 , e \_ i} \vert {a}_{t} , {s}_{t} ) , p {\hat{}}_{1} ( {s}_{t + 1 , e \_ i} \vert {a}_{t} , {s}_{t} ) ) {\sum }_{{t}^{′} = t}^{∞} {r}_{{t}^{′}} \vert & ( 8 )\end{matrix}$$

In Expression (8), for each time step and for each element of the state, the variance of that element in the output of models p\hat{ }₀ and p\hat{ }₁, “Var(p\hat{ }₀(s_{t+1, e_i}|aₜ, sₜ), p\hat{ }₁(s_{t+1, e_i}|aₜ, sₜ))”, is multiplied by the cumulative reward from that time step onwards, “Σ_{t′=t}^{∞}r_{t′}”.

Expression (8) can be interpreted as indicating that, among the elements of the state predicted by the model, the more ambiguous the element is and the more it contributes to the cumulative reward, the more important it is.

Regarding Expression (8), in a case where there are a plurality of pseudo trajectories, the analysis portion 230 may further calculate the sum of the importance I(s_{e_i}) shown in Expression (8) for all the pseudo trajectories.

In this way, the analysis portion 230 calculates the importance of each element of the states output by the models p\hat{ }₀ and p\hat{ }₁, and outputs the calculated importance as the analysis result.

However, the importance calculated by the analysis portion 230 is not limited to those shown in the above expressions (7) and (8), and various other values are possible.

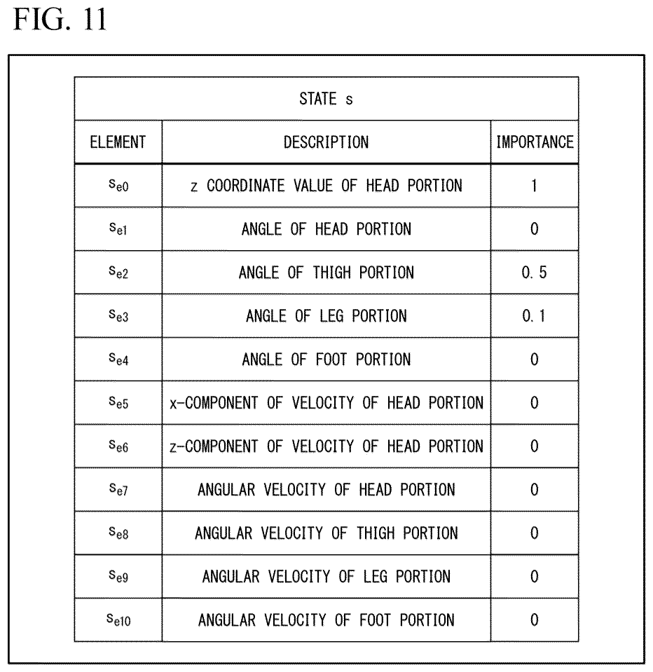

FIG. 11 is a diagram showing an example of a display screen of the importance of state elements displayed by the display portion 120.

In the example of FIG. 11, the display portion 120 displays the identification information “sₑ₀”, “sₑ₁”, . . . , “sₑ₁₀” of each element included in the state, a description of each element, and the importance of each element as calculated by the analysis portion 230.

With reference to the display screen shown in FIG. 11, the user can determine that the greater the importance value of an element, the more important it is to improve the accuracy. Specifically, the user can determine that improving the accuracy of element sₑ₀ is most important, followed by improving the accuracy of the element sₑ₂, and then improving the accuracy of the element sₑ₃.

For example, consider the case where a user is considering introducing one of the following two constraint equations into the search for a model.

The first constraint equation that the user considers is shown as Expression (9).

$$\begin{matrix}[ Expression 9 ] & \\ {s}_{t + 1 , e 0} = {s}_{t , e 0} + {s}_{t , e 6} * {c}_{1} & ( 9 )\end{matrix}$$

Expression (9) represents the constraint condition that the z coordinate value of the head portion 911 at time step t plus the value obtained by multiplying the velocity in the z-axis direction by coefficient c₁ represents the z coordinate value of the head portion 911 at time step t+1.

The second constraint expression that the user considers is shown as Expression (10).

$$\begin{matrix}[ Expression 10 ] & \\ {s}_{t + 1 , e 2} \leq {s}_{t , e 2} + {c}_{2} * {a}_{t , e 0} & ( 10 )\end{matrix}$$

Expression (10) shows the constraint condition that the angle calculated by adding the torque applied to the rotor of the thigh portion 912 multiplied by the coefficient c₂ to the angle of the thigh portion 912 at time step t represents the angle of the thigh portion 912 at time step t+1.

Since both expressions (9) and (10) require investigation of coefficient values, it is assumed that the user is considering employing only one of these two constraint equations. In this case, the user can refer to the importance calculated by the analysis portion 230 and select one of the two constraint equations.

Because Expression (9) references state elements sₑ₀ and sₑ₆, the user adds the importance of these two elements, I(sₑ₀)=1 and I(sₑ₆)=0, to calculate the importance of Expression (9) as 1.

On the other hand, since Expression (10) refers to state element sₑ₂, the user sets the importance I(sₑ₂)=0.5 of state element sₑ₂ as the importance of Expression (10). Since the importance of Expression (9) is greater than the importance of Expression (10), the user adopts Expression (9). The user obtains the value of the coefficient c1, for example, by actual measurement, and sets it in Expression (9).

The user may generate a constraint equation by focusing on an element with high importance. For example, the user may decide to focus on element sₑ₀, which has the highest importance, and generate a constraint equation for the z-coordinate value of the head portion 911.

In Step S9 of FIG. 5, the user inputs the selected Expression (9) to the learning device 100 as feedback information, and the feedback information acquisition portion 240 acquires the feedback information that was input.

In Step S10 of FIG. 5, the model management portion 221 adds Expression (9), in which the value of coefficient c₁ is set, to the constraint condition in a case of searching for models p\hat{ }₀ and p\hat{ }₁, and performs a model search. The model management portion 221 may search for the model p\hat{ }₀ based on Expression (11).

$$\begin{matrix}[ Expression 11 ] & \\ p {\hat{}}_{0} ← {arg min}_{p \hat{}} ( - log p \hat{} ( {s}_{t + 1} \vert {s}_{t} , {a}_{t} ) + {( {s}_{t + 1 , e 0} - {s}_{t , e 0} - {s}_{t , e 6} * {c}_{1} )}^{2} ) & ( 11 )\end{matrix}$$

“←” represents a substitution. Expression (11) represents the substitution of the model p\hat{ } obtained by the right-hand side calculation for the model p\hat{ }₀. That is, it indicates adoption of the model as model p\hat{ }₀.
argmin is a function that outputs parameter values that minimize the value of the objective function. The model management portion 221 searches for model p\hat{ } such that the value of “−log p\hat{ }(sₜ₊₁|sₜ, aₜ)+(s_{t+1, e0}−s_{t, e0}−s_{t, e6}*c₁)²” is smaller in accordance with Expression (11), and adopts the acquired model p\hat{ } as model p\hat{ }₀.
“*” denotes multiplication.

“−log p\hat{ }(sₜ₊₁|sₜ, aₜ)” is a term whose value decreases as the likelihood of the state-action pair included in the data set Den, increases. Specifically, “−log p\hat{ }(sₜ₊₁|sₜ, aₜ)” is a term whose value becomes smaller the closer the next state output by model p\hat{ } after receiving input of state sₜ and action aₜ is to the next state sₜ₊₁ indicated in the dataset Dₑₙᵥ.

“(s_{t+1, e0}−s_{t, e0}−s_{t, e6}*c₁)²” is a term whose value becomes smaller the higher the degree to which the next state output by the model p\hat{ } upon receiving the input of state sₜ and action aₜ satisfies Expression (9) adopted as the constraint equation.

As in the case of model p\hat{ }₀, the model management portion 221 may search for model p\hat{ }₁ based on Expression (12).

$$\begin{matrix}[ Expression 12 ] & \\ p {\hat{}}_{1} ← {arg min}_{{p}^{′ \hat{}}} ( - log {p}^{′} \hat{} ( {s}_{t + 1} \vert {s}_{t} , {a}_{t} ) + {( {s}_{t + 1 , e 0} - {s}_{t , e 0} - {s}_{t , e 6} * {c}_{1} )}^{2} ) & ( 12 )\end{matrix}$$

The model management portion 221 may search for a model using the dataset Dₑₙᵥ. For example, the model management portion 221 may apply the state, sₜ, action aₜ, next state sₜ₊₁, s_{t, e0}, which is the element e₀ of state sₜ, s_{t, e6}, which is the element e₆ of state sₜ, and s_{t+1, e0}, which is the element e₀ of next state sₜ₊₁, shown in the quadruple contained in the dataset Dₑₙᵥ, to expressions (11) and (12) to search for models p\hat{ }₀ and p\hat{ }₁.

Alternatively, the model management portion 221 may search for a model based on the data set D_{model} in addition to or instead of the data set Dₑₙᵥ.

The user may input a plurality of constraint equations to the learning device 100. In this case, the model management portion 221 may calculate the importance of each of the above-mentioned constraint equations, and weight the constraint equations based on the calculated importance.

For example, the model management portion 221 may search for the model p\hat{ }₀ based on Expression (13).

$$\begin{matrix}[ Expression 13 ] & \\ p {\hat{}}_{0} ← {arg min}_{p \hat{}} ( - log p \hat{} ( {s}_{t + 1} \vert {s}_{t} , {a}_{t} ) + {{α}_{1} ( {s}_{t + 1 , e 0} - {s}_{t , e 0} - {s}_{t , e 6} * {c}_{1} )}^{2} + {{α}_{2} ( R e L U ( {s}_{t + 1 , e 2} - {s}_{t , e 2} - {c}_{2} * {a}_{t , e 0} ) )}^{2} ) & ( 13 )\end{matrix}$$

ReLU stands for Ramp Function. The value of “ReLU(sₜ₊₁, e₂−s_{t, e2}−c₂*a_{t, e0})” is 0 if Expression (10) holds, and if Expression (10) does not hold, it is the value of “s_{t+1, e}₂−s_{t, e2}−c₂*a_{t, e0}”, that is, the value obtained by subtracting the right side of Expression (10) from the left side.

“(ReLU(s_{t+1, e2}−s_{t, e2}−c₂*a_{t, e0}))²” is a term that is 0 if the next state output by model p\hat{ } upon receiving input of state sₜ and action aₜ satisfies Expression (10) adopted as the constraint equation, and if Expression (10) is not satisfied, the smaller the degree of deviation, the smaller the value becomes.

α₁ is a weight coefficient for “(s_{t+1, e0}−s_{t, e0}−s_{t, e6}*c₁)²”. α₁ is a weight coefficient for “(ReLU(s_{t+1, e2}−s_{t, e2}−c₂*a_{t, e0}))²”.

For example, the model management portion 221 calculates the importance of Expression (9) as 1, and the importance of Expression (10) as 0.5, in the same manner as above. Then, the model management portion 221 normalizes the calculated importance to calculate a₁=1/(1+0.5) and c₂=0.5/(1+0.5).

The model management portion 221 uses the weight coefficient exemplified in Expression (13), s₀ that among the constraint equations set by the user, a constraint equation with a higher importance is more strongly reflected in the model search. In this respect, the accuracy of the resulting model is expected to be high.

The learning device 100 may be configured to eliminate the need for a user to input feedback information during model learning and policy learning.

For example, the storage portion 180 may store in advance constraint equations based on the user's knowledge, such as the above expressions (9) and (10). Then, in Step S9 of FIG. 5, the feedback information acquisition portion 240 may calculate the importance of each constraint equation as described above, and select the constraint equation with the highest importance. Alternatively, the feedback information acquisition portion 240 may select a plurality of constraint equations based on the importance of each constraint equation, for example, by selecting a predetermined number of constraint equations in order of importance.

(2) The case where the analysis result indicates the accuracy of each of a plurality of pseudo trajectories, and the feedback information indicates a correction value of the pseudo trajectory or information on whether the value indicated in the pseudo trajectory is correct

In the following, an example will be described in which the learning portion 220 generates a pseudo trajectory six times. The pseudo trajectories are denoted as τ₀, τ₁, . . . , τ₅. However, the number of pseudo trajectories generated by the learning portion 220 is not limited to a specific number as long as it is two or more.

The state and action at time step t included in the j-th (j is an integer 0≤j≤5) pseudo trajectory τⱼ are denoted as s_{t, τj} and a_{t, τj}, respectively.

In Step S8 of FIG. 5, the analysis portion 230 calculates the importance of each pseudo trajectory based on, for example, Expression (14).

$$\begin{matrix}[ Expression 14 ] & \\ I ( {τ}_{j} ) = \vert {\sum }_{t = 0}^{∞} Var ( p {\hat{}}_{0} ( {s}_{t + 1 , {τ}_{j}} \vert {a}_{t , {τ}_{j}} , {s}_{t , {τ}_{j}} ) , p {\hat{}}_{1} ( {s}_{t + 1 , {τ}_{j}} \vert {a}_{t , {τ}_{j}} , {s}_{t , {τ}_{j}} ) ) \vert & ( 14 )\end{matrix}$$

I(τⱼ) indicates the importance of the pseudo trajectory τⱼ. Based on Expression (14), the analysis portion 230 calculates the variance between the next state sₜ₊₁, τⱼ output by model p\hat{ }₀ and the next state sₜ₊₁, τⱼ output by model p\hat{ }₁ for each pseudo trajectory and for each time step, and sums up the variances for all time steps in the pseudo trajectory to obtain the importance I(τⱼ).

The importance I(τⱼ) corresponds to an example of an evaluation index value for the accuracy of time-series data.

Expression (14) can be interpreted as indicating that the state predicted by the model is more important for globally ambiguous pseudo trajectories. A pseudo trajectory in which the state predicted by the model is globally ambiguous can be said to be a pseudo trajectory in which the prediction accuracy by the model is low when all time steps included in the pseudo trajectory are considered comprehensively.

As explained for Expression (7), ∞ in E in Expression (14) also indicates that the number of time steps in the pseudo trajectory is arbitrary. The analysis portion 230 sums up the variances for each time step up to the last time step in the simulated trajectory.

However, the importance calculated by the analysis portion 230 is not limited to that shown in the above Expression (14), and various other values are possible.

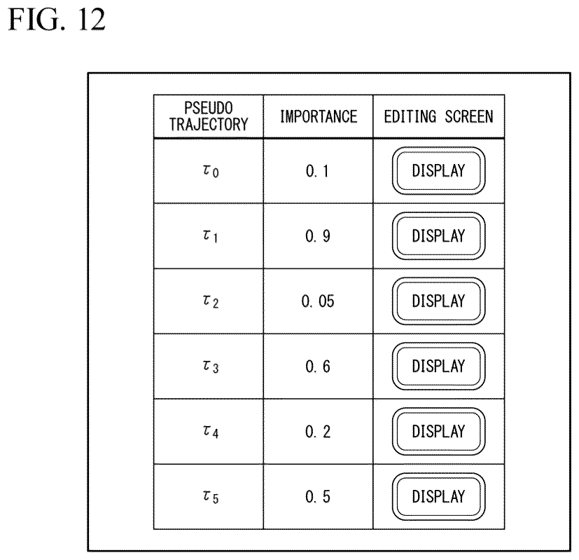

FIG. 12 is a diagram showing an example of a display screen of the importance of the pseudo trajectory displayed by the display portion 120.

In the example of FIG. 12, the display portion 120 displays identification information “τ₀”, “τ₁” . . . . “τ₅” of each pseudo trajectory, the importance of each pseudo trajectory, and a button icon for accepting a user operation to request the display of an editing screen for each pseudo trajectory.

With reference to the display screen shown in FIG. 12, the user can determine that the greater the importance value of a pseudo trajectory, the more important it is to improve the accuracy. Specifically, the user can prioritize the pseudo trajectories in such a way that improving the accuracy of the pseudo trajectory τ₁ is most important, followed by improving the accuracy of the pseudo trajectory τ₃, and then improving the accuracy of the pseudo trajectory τ₅.

If correcting all the pseudo trajectories is too much of a burden for the user, the user can select the pseudo trajectories to be corrected based on their importance. Let us assume that the user has decided to correct the pseudo trajectories τ₁ and τ₃.

In Step S9 of FIG. 5, the user corrects the pseudo trajectory, and the feedback information acquisition portion 240 acquires feedback information indicating the correction of the pseudo trajectory.

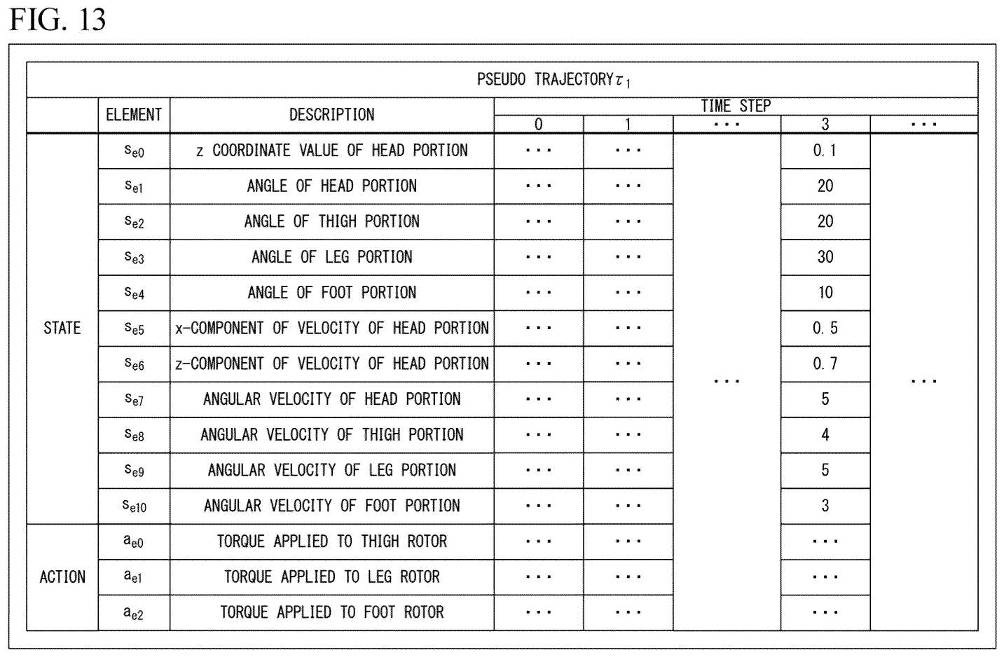

FIG. 13 is a diagram showing an example of an editing screen for the pseudo trajectory τ₁ displayed by the display portion 120. If a button icon shown in the row of the pseudo trajectory τ₁ on the display screen of FIG. 12 is pressed, the display portion 120 displays the edit screen of FIG. 12.

In the example of FIG. 13, the display portion 120 displays the value of each element of the state s and the value of each element of the action a for the pseudo trajectory τ₁ for each time step. The user corrects the pseudo trajectory by correcting the values of the displayed state elements.

For the value of the element of action a, the display portion 120 displays it as reference information for the user to obtain the correct value of the element of state. Alternatively, the value of an element of action a may also be subject to correction by the user.

FIG. 14 is a diagram showing an example of an editing screen of a pseudo trajectory after modification by the user, displayed on the display portion 120.

FIG. 14 shows an example of a case where a user performs a correction operation on the editing screen shown in FIG. 13. The user corrects the values of elements sₑ₀ and sₑ₂ of state s at time step 3. It is assumed here that the user has knowledge of the correct values of these elements, such as being able to calculate the values.

In the example of FIG. 14, the display portion 120 displays the corrected value with an underline.

The state of the control target 810 at time step t denoted by the trajectory τⱼ, after the user has made a correction to the state s_{t, τj} of the control target 810, is represented by s_{t, τj, f}.

Weighting based on the reliability of the pseudo trajectory elements is also introduced. The elements of a pseudo trajectory here are elements of a state shown in the pseudo trajectory. In the case where the action is also subject to correction by the user, the elements of the action shown in the pseudo trajectory are also referred to as elements of the pseudo trajectory.

The user sets the weight values based on the user's own judgment as to whether the elements of the pseudo trajectory are correct or incorrect. For example, the user sets the weight value to 1 for an element that the user determines to be correct. Furthermore, the user sets the weight value to 0 for an element for which the correctness of the value is unknown. Furthermore, the user sets the weight value for an element that is determined to have an incorrect value to −1.

For a pseudo trajectory that has been corrected, the user sets the weight value with the corrected pseudo trajectory as the target.

The weight setting value is also an example of feedback information.

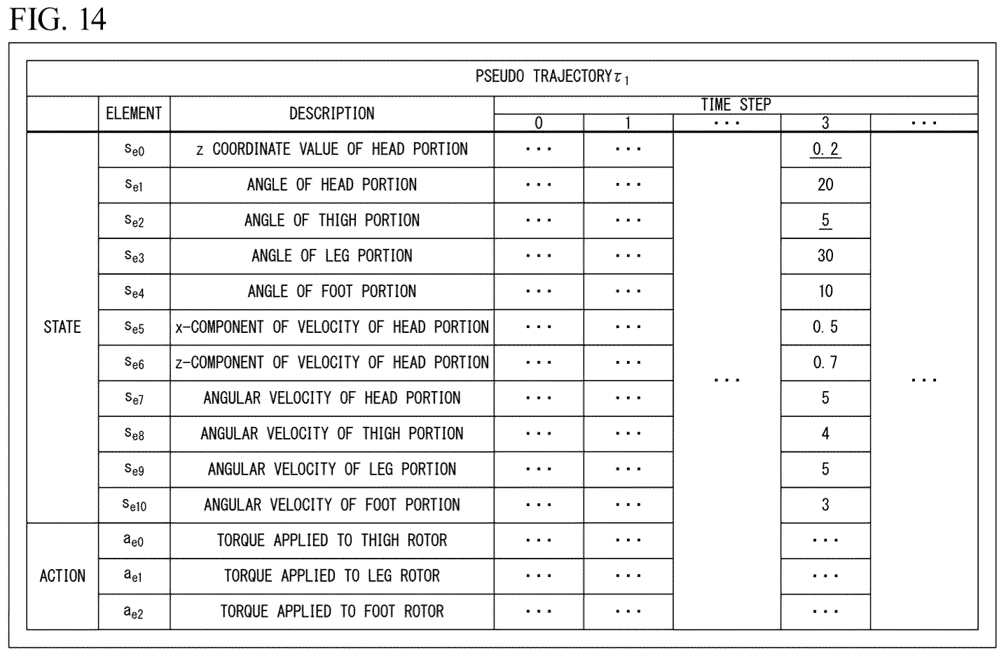

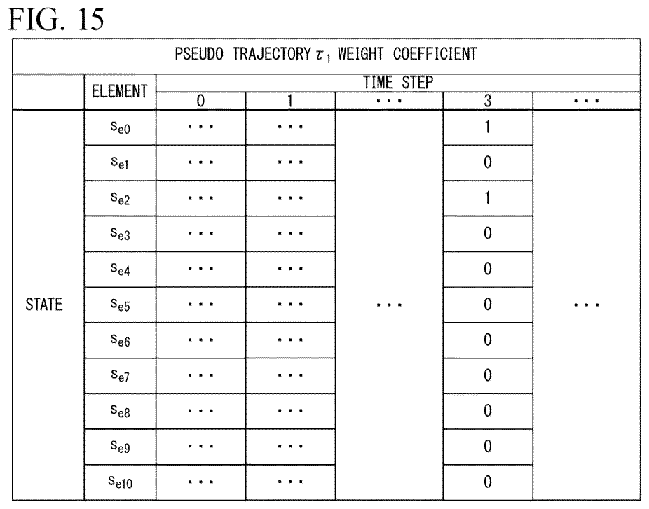

FIG. 15 is a diagram showing an example of a screen displayed by the display portion 120 for setting weights for elements of the pseudo trajectory τ₁.

FIG. 15 shows an example of weights set by the user for the element values shown in FIG. 14. The user determines that, among the elements of the state at time step 3, the corrected value of element sₑ₀ and the corrected value of element sₑ₂ are correct, and sets the weight value to 1.

On the other hand, the user determines that the values of elements sₑ₁, sₑ₃, sₑ₄, . . . , sₑ₁₀ are unclear as to whether they are correct or incorrect, and sets the weight value to 0.

This weight is used in a case where the model management portion 221 updates the model using feedback information. For example, by using this weight, the model management portion 221 can filter out the values of elements that the user judges to be correct or incorrect values.

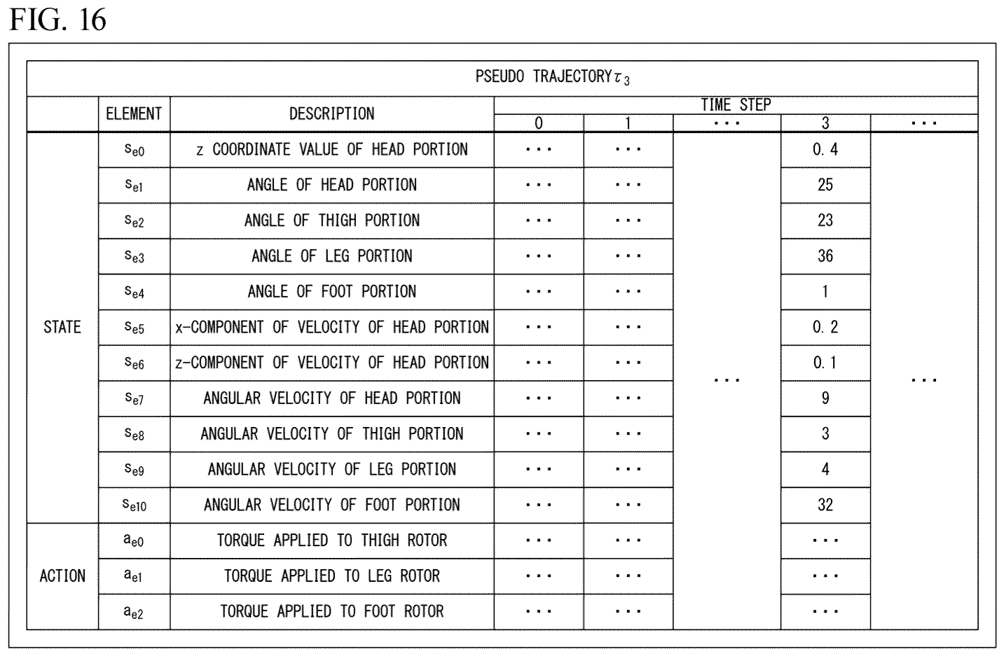

FIG. 16 is a diagram showing an example of an editing screen for the pseudo trajectory τ₃ displayed by the display portion 120. If a button icon shown in the row of the pseudo trajectory τ₃ on the display screen of FIG. 12 is pressed, the display portion 120 displays the edit screen of FIG. 16.

For the pseudo trajectory 13, the user does not correct the element values but only sets the weights.

FIG. 17 is a diagram showing an example of a screen displayed by the display portion 120 for setting weights for elements of the pseudo trajectory τ₃.

FIG. 17 shows an example of weights set by the user for the element values shown in FIG. 16. The user has determined that, among the elements of the state at time step 3, the values of elements sₑ₄ and sₑ₀ are correct and therefore has set the weight values thereof to 1.

On the other hand, the user has determined that the values of elements sₑ₀, sₑ₂, sₑ₅, sₑ₇, s_{e8,} and sₑ₁₀ are unclear as to whether they are correct or incorrect, and therefore has set the weight values thereof to 0.

Furthermore, the user has determined that the values of elements sₑ₁, sₑ₃, and sₑ₆ are incorrect and therefore has set the weight values thereof to −1.

In Step 10 of FIG. 5, the model management portion 221 uses the obtained feedback information to search for a model. The model management portion 221 may search for the model p\hat{ }₀ based on Expression (15).

$$\begin{matrix}[ Expression 15 ] & \\ p {\hat{}}_{0} ← {arg min}_{p \hat{}} ( - log p \hat{} ( {s}_{t + 1} \vert {s}_{t} , {a}_{t} ) - {\sum }_{j ∈ \{ 1 , 3 \}} {\sum }_{{t}^{′} = 0}^{∞} ( {w}_{{t}^{′} , {τ}_{j}} \cdot p \hat{} ( {s}_{{t}^{′} + 1 , {τ}_{j} , f} \vert {s}_{{t}^{′} , {τ}_{j}} , {a}_{{t}^{′} , {τ}_{j}} ) ) ) & ( 15 )\end{matrix}$$

With regard to state s_{t′+1, τj, f}, in a case where no correction has been made to state s_{t′+1, τj}, the value of state s_{t′+1, τj} is used as the value of state s_{t′+1, τj, f} as is. In addition, in a case where corrections have been made to only some of the elements included in state s_{t′+1, τj, f}, for the elements that have not been corrected, the values of those elements in state s_{t′+1, τj} are used as is.
“w_{t′, τj}” is a vector indicating the weight set for each element of the state s_{t′, τj} of the control target 810 at time step the t′ indicated in the trajectory τⱼ.

In Expression (15), the weight “w_{t′, τj}” is represented by a horizontal vector. In addition, the likelihood “p′\hat{ }(s_{t+1, τj, f}|s_{t′, τj}, a_{t′, j})” that the model p\hat{ } will output the next state s_{t′+1, τj, f} shown in the corrected trajectory τj for the input of state s_{t′, τj} and action a_{t′, τj} is represented by a vertical vector for each element of the state.

In “w_{t′, τj·p′\hat{ }(s}_{t′=1, τj, f}|s_{t′, τj}, a_{t′, τj}),” the inner product of the weight vector “w_{t′, τj}” and the likelihood vector “p′\hat{ }(s_{t′+1, τj, f}|s_{t′, τj}, a_{t′, τj})” is taken.

Therefore, for an element whose weight value is set to 1, the value of this inner product equation becomes larger as the likelihood that the model p\hat{ } will output the value of that element in the next state in state s_{t′+1, τj, f} shown in the corrected pseudo trajectory τj increases.

On the other hand, elements whose weight value is set to 0 are filtered out in the calculation of the value of this inner product equation. That is, for elements whose weight value is set to 0, the value output by the model p\hat{ } does not affect the value of the inner product expression.

In addition, for an element whose weight value is set to −1, the value of this inner product equation becomes smaller as the likelihood that the model p\hat{ } will output the value of that element in the next state in state s_{t′+1, τj, f} shown in the corrected pseudo trajectory τj increases.

The model management portion 221 searches for the model p\hat{ }₀ using Expression (15), thereby reflecting the correction of the pseudo trajectory and the weight setting by the user in the search for the model. In this respect, the accuracy of the resulting model is expected to be high.

However, it is not essential that the user sets a weight. If the user does not perform weight setting, the model management portion 221 may set all weight values to 1 and perform a model search.

As in the case of model p\hat{ }₀, the model management portion 221 may search for model p\hat{ }₁ based on Expression (16).

$$\begin{matrix}[ Expression 16 ] & \\ p {\hat{}}_{1} ← {arg min}_{{p}^{′ \hat{}}} ( - log {p}^{′} \hat{} ( {s}_{t + 1} \vert {s}_{t} , {a}_{t} ) - {\sum }_{j ∈ \{ 1 , 3 \}} {\sum }_{{t}^{′} = 0}^{∞} ( {w}_{{t}^{′} , {τ}_{j}} \cdot {p}^{′} \hat{} ( {s}_{{t}^{′} + 1 , {τ}_{j} , f} \vert {s}_{{t}^{′} , {τ}_{j}} , {a}_{{t}^{′} , {τ}_{j}} ) ) ) & ( 16 )\end{matrix}$$

The model management portion 221 may search for a model using the dataset Dₑₙᵥ. Alternatively, the model management portion 221 may search for a model based on the data set D_{model} in addition to or instead of the data set Dₑₙᵥ.

As described above, the model management portion 221, through training using data that links the state of the environment where an agent performs an action, the actions that can be performed in that state, and the next state in a case where the action is performed in that state, and acquires models p\hat{ }₀ and p\hat{ }₁ that take the state and action as input and the next state as output. Based on the acquired model, the feedback information acquisition portion 240 acquires feedback information, which is information that is used for training the model or for training a new model in which the state and action are input and the next state is output. The policy management portion 222 performs training of policies that indicate the action of the agent according to the state, using a model obtained using the feedback information.

According to the learning device 100, in a case where sufficient data is not obtained from the previously obtained dataset Dₑₙᵥ, the model management portion 221 can compensate for the lack of information with the feedback information, whereby it is expected that a relatively accurate model can be obtained. It is expected that by having the policy management portion 222 use this model to train policies (learn control over the control target 810), the accuracy of control learning in a state where sufficient data is not available can be improved.

Furthermore, the feedback information acquisition portion 240 acquires the feedback information indicating constraint conditions that must be satisfied by the input data and output data of the model to be trained. The model management portion 221 searches for a model using the constraint conditions.

According to the learning device 100, a model can be obtained in which the constraint condition is reflected in the relationship between the input data and the output data, and in this respect, it is expected that a relatively accurate model can be obtained.

Furthermore, the analysis portion 230 calculates, for each item included in the information indicating the state, an evaluation index value for the accuracy of that item in the next state output by the acquired model. The feedback information acquisition portion 240 acquires feedback information indicating constraint conditions related to items with relatively low accuracy evaluations.

According to the learning device 100, the accuracy of items included in the information indicating the state, for which the accuracy of the values output by the model is relatively low, is improved based on the constrain condition, and in this respect, it is expected that the accuracy of the model can be improved efficiently.

The display portion 120 also displays an evaluation index value of the accuracy of the item in the next state output by the acquired model. The operation input portion 130 accepts a user operation for inputting feedback information. After the display portion 120 starts displaying the evaluation index values, the feedback information acquisition portion 240 acquires feedback information input by a user operation received by the operation input portion 130.

According to the learning device 100, the model management portion 221 searches for a model using feedback information, s₀ that user knowledge according to the accuracy of the model can be reflected in the model search. In this respect, the learning device 100 is expected to be able to obtain a relatively accurate model relatively efficiently.

Furthermore, the feedback information acquisition portion 240 acquires feedback information indicating corrections to the input/output data of the obtained model. The model management portion 221 performs model training using the input/output data in which the corrections have been reflected.

According to the learning device 100, since the model is trained using input/output data in which corrections have been reflected, it is expected that a relatively accurate model can be obtained.

Furthermore, for each of the multiple time-series data of the input and output of the obtained model, the analysis portion 230 calculates an evaluation index value of the accuracy of the time-series data. The feedback information acquisition portion 240 acquires feedback information indicating corrections to time-series data whose accuracy has been evaluated as relatively low.

According to the learning device 100, among the plurality of time-series data, time-series data with a relatively low evaluation of accuracy is corrected. It is expected that the model management portion 221, by training a model using the corrected time-series data, can relatively efficiently improve the accuracy of the model.

For each of the multiple time-series data of the input and output of the obtained model, the display portion 120 displays an evaluation index value of the accuracy of the time-series data. The operation input portion 130 accepts a user operation for inputting feedback information. After the display portion 120 starts displaying the evaluation index values, the feedback information acquisition portion 240 acquires feedback information input by a user operation received by the operation input portion 130.

According to the learning device 100, by training a model using feedback information, the model management portion 221 can train the model using data whose values have been corrected by the user for time-series data with relatively low accuracy among multiple time-series data. In this respect, the learning device 100 is expected to be able to obtain a relatively accurate model relatively efficiently.

The display portion 120 displays, for each item included in information indicating a next state output by a model simulating an environment in which an agent performs an action in response to input of information indicating a state and information indicating an action, an evaluation index value of the accuracy of that item in the information indicating the next state.

According to the learning device 100, a user can refer to the index values displayed by the display portion 120 and input feedback information to the learning device 100 for improving items with low accuracy in the model output. In this regard, it is expected that the learning device 100 can efficiently improve the accuracy of the model.

The display portion 120 also displays an evaluation index value for the accuracy of each of the multiple time-series data of the state in the environment and the agent's actions, which is time-series data of the input and output of the model that simulates the environment in which the agent performs actions.

According to the learning device 100, a user can refer to the index values displayed by the display portion 120 and select and correct time-series data with low accuracy. In this regard, it is expected that the learning device 100 can efficiently improve the accuracy of the model.

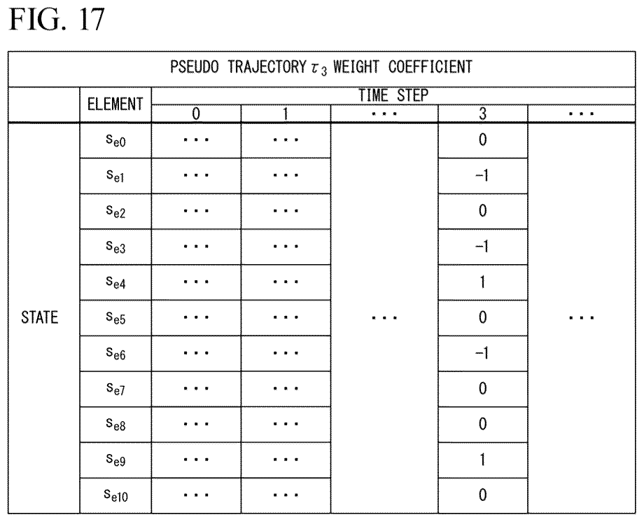

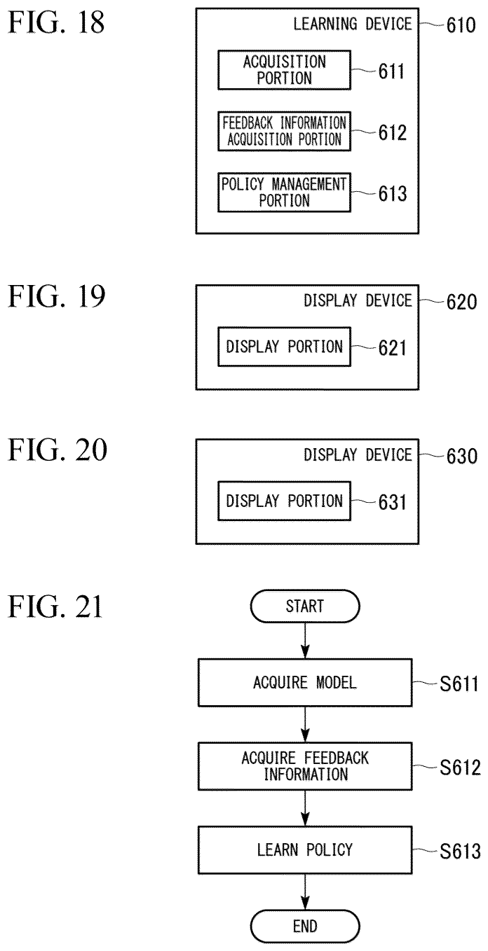

FIG. 18 is a diagram showing another example of the configuration of the learning device according to an embodiment. In the configuration shown in FIG. 18, a learning device 610 includes a model acquisition portion 611, a feedback information acquisition portion 612, and a policy management portion 613.

With this configuration, the model acquisition portion 611, through training using data that links the state of the environment where an agent performs an action, the actions that can be performed in that state, and the next state in a case where the action is performed in that state, acquires a model that takes the state and action as input and the next state as output. Based on the acquired model, the feedback information acquisition portion 612 acquires feedback information, which is information that is used for training the model or for training a new model in which the state and action are input and the next state is output. The policy management portion 613 performs training of policies that indicate the action of the agent according to the state, using a model obtained using the feedback information.

The model acquisition portion 611 corresponds to an example of a model acquisition means. The feedback information acquisition portion 612 corresponds to an example of a feedback information acquisition means. The policy management portion 613 corresponds to an example of a policy management means.

According to the learning device 610, for a state in which sufficient data is not obtained from the previously obtained data, the model acquisition portion 611 can compensate for the lack of information with the feedback information, whereby it is expected that a relatively accurate model can be obtained. By performing training of policies using this model, it is expected that the policy management portion 613 will be able to improve the accuracy of control learning in states where sufficient data is not available.

The model acquisition portion 611 can be realized by using functions such as the model management portion 221 in FIG. 1. The feedback information acquisition portion 612 can be realized by using functions such as the feedback information acquisition portion 240 in FIG. 1. The policy management portion 613 can be realized by using functions such as the policy management portion 222 in FIG. 1.

FIG. 19 is a diagram showing an example of the configuration of a display device according to the embodiment. In the configuration shown in FIG. 19, the display device 620 includes a display portion 621.

With this configuration, the display portion 621 displays, for each item included in information indicating a next state output by a model simulating an environment in which an agent performs an action in response to input of information indicating a state and information indicating an action, an evaluation index value of the accuracy of that item in the information indicating the next state.

The display portion 621 corresponds to an example of a display means.

According to the display device 620, a user, referring to the index values displayed by the display portion 621, can input feedback information to the display device 620 for improving items with low accuracy in the model output. In this regard, it is expected that the display device 620 can efficiently improve the accuracy of the model. The display portion 621 can be realized by using the functions of the display portion 120 in FIG. 1.

FIG. 20 is a diagram showing another example configuration of the display device according to the embodiment. In the configuration shown in FIG. 20, the display device 630 includes a display portion 631.

With this configuration, the display portion 631 also displays an evaluation index value for the accuracy of each of the multiple time-series data of the state in the environment and the agent's actions, which is time-series data of the input and output of the model that simulates the environment in which the agent performs actions.

The display portion 631 corresponds to an example of a display means.

According to the display device 630, a user can refer to the index values displayed by the display portion 631 and select and correct time-series data with low accuracy. In this regard, it is expected that the display device 630 can efficiently improve the accuracy of the model.

The display portion 631 can be realized by using the functions such as the display portion 120 in FIG. 1.

FIG. 21 is a diagram showing an example of processing steps in a learning method according to the embodiment. The learning method shown in FIG. 21 includes acquiring a model (Step S611), acquiring feedback information (Step S612), and training a policy (Step S613).

In acquiring a model (Step S611), a computer, based on data that links the state of the environment where an agent performs an action, the actions that can be performed in that state, and the next state in a case where the action is performed in that state, acquires a model that takes the state and action as input and the next state as output.

In acquiring feedback information (Step S612), the computer acquires feedback information, which is information for acquiring a more accurate model, based on the output of the acquired model.

In training a policy (Step S613), the computer trains a policy indicating the action of the agent according to the state, using a model obtained using the feedback information.

According to the learning method shown in FIG. 21, for a state in which sufficient data is not obtained from the previously obtained data, it is possible to compensate for the lack of information with the feedback information, whereby it is expected that a relatively accurate model can be obtained. By performing training of policies using this model, it is expected that the accuracy of control learning in a state can be improved, even for states where sufficient data is not available.

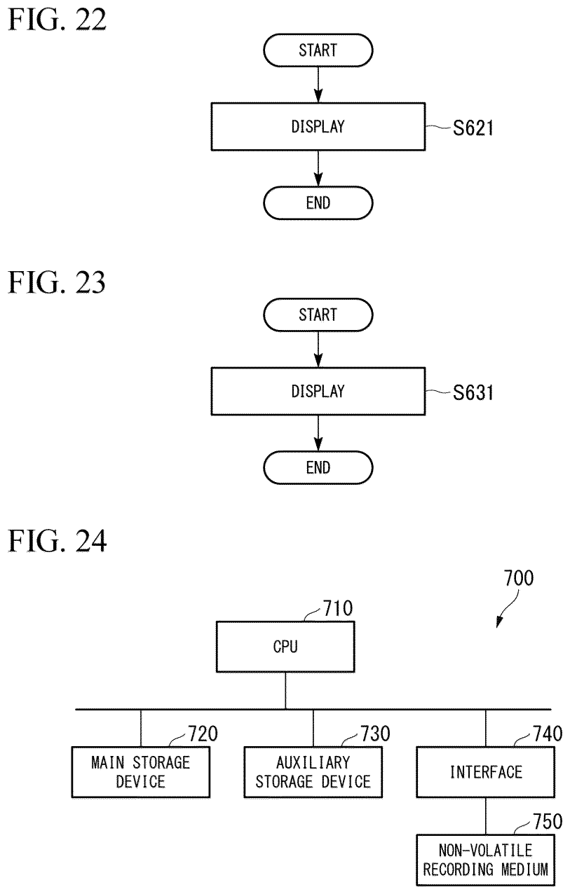

FIG. 22 is a diagram showing an example of processing steps in the display method according to the embodiment. The display method shown in FIG. 22 includes performing display (Step S621).

In performing display (Step S621), for each item included in information indicating a next state output by a model simulating an environment in which an agent performs an action in response to input of information indicating a state and information indicating an action, a computer displays an evaluation index value of the accuracy of that item in the information indicating the next state.

According to the display method shown in FIG. 22, a user, referring to the displayed index values, can input feedback information to the computer to improve items with low accuracy in the model output. In this respect, it is expected that the display method shown in FIG. 22 can effectively improve the accuracy of the model.

FIG. 23 is a diagram showing another example of processing steps in the display method according to the embodiment. The display method shown in FIG. 23 includes performing display (Step S621).

In performing display (Step S631), the computer displays an evaluation index value for the accuracy of each of the multiple time-series data of the state in the environment and the agent's actions, which is time-series data of the input and output of the model that simulates the environment in which the agent performs actions.

According to the display method shown in FIG. 23, the user, referring to the displayed index values, can select and correct time-series data with low accuracy. In this respect, it is expected that the display method shown in FIG. 23 can effectively improve the accuracy of the model.

FIG. 24 is a schematic block diagram illustrating the configuration of a computer according to at least one embodiment.

In the configuration shown in FIG. 24, a computer 700 includes a CPU 710, a main storage device 720, an auxiliary storage device 730, an interface 740, and a non-volatile recording medium 750.

Any one or more of the above-mentioned learning device 100, learning device 610, display device 620, and display device 630, or a part thereof, may be implemented in the computer 700. In this case, the operations of the above-mentioned processing portions are stored in the auxiliary storage device 730 in the form of a program. The CPU 710 reads the program from the auxiliary storage device 730, loads it into the main storage device 720, and executes the above-mentioned processing in accordance with the program. Furthermore, the CPU 710 allocates storage areas in the main storage device 720 corresponding to the above-mentioned respective storage portions in accordance with the program. Communication between each device and other devices is performed by the interface 740 having a communication function and performing communication under the control of the CPU 710. The interface 740 also has a port for a non-volatile recording medium 750, and reads information from the non-volatile recording medium 750 and writes information to the non-volatile recording medium 750.

In a case where the learning device 100 is implemented in a computer 700, the operations of the processing portion 190 and each of the portions thereof are stored in the auxiliary storage device 730 in the form of a program. The CPU 710 reads the program from the auxiliary storage device 730, loads it into the main storage device 720, and executes the above-mentioned processing in accordance with the program.

Furthermore, the CPU 710 allocates storage areas in the main storage device 720 corresponding to the storage portion 180 and each of the components thereof in accordance with the program. The communication performed by the communication portion 110 is implemented by the interface 740 having a communication function and performing communication under the control of the CPU 710. The display of images by the display portion 120 is performed by having the interface 740 equipped with a display device and displaying images under the control of the CPU 710. The receipt of user operations by the operation input portion 130 is executed by the interface 740 being equipped with an input device and receiving the user operations.

In a case where the learning device 610 is implemented in the computer 700, the operations of the model acquisition portion 611, the feedback information acquisition portion 612, and the policy management portion 613 are stored in the auxiliary storage device 730 in the form of a program. The CPU 710 reads the program from the auxiliary storage device 730, loads it into the main storage device 720, and executes the above-mentioned processing in accordance with the program.

Furthermore, the CPU 710 reserves a memory area in the main storage device 720 for the learning device 610 to perform processing in accordance with the program. Communication between the learning device 610 and other devices is performed by the interface 740 having a communication function and operating under the control of the CPU 710. Interaction between the learning device 610 and the user is carried out by the interface 740, which has a display device and an input device, displaying various images under the control of the CPU 710, and accepting user operations.

In a case where the display device 620 is implemented in the computer 700, its operation is stored in the auxiliary storage device 730 in the form of a program. The CPU 710 reads the program from the auxiliary storage device 730, loads it into the main storage device 720, and executes the above-mentioned processing in accordance with the program.

Furthermore, the CPU 710 reserves a storage area in the main storage device 720 for the display device 620 to perform processing in accordance with the program. Communication between the display device 620 and other devices is performed by an interface 740 having a communication function and operating under the control of the CPU 710. The display of images by the display portion 621 is performed by the interface 740, which is equipped with a display device, displaying images under the control of the CPU 710. The reception of user operations on the display device 620 is executed by the interface 740 having an input device and receiving the user operations.

In a case where the display device 630 is implemented in the computer 700, its operation is stored in the auxiliary storage device 730 in the form of a program. The CPU 710 reads the program from the auxiliary storage device 730, loads it into the main storage device 720, and executes the above-mentioned processing in accordance with the program.

Furthermore, the CPU 710 reserves a storage area in the main storage device 720 for the display device 630 to perform processing in accordance with the program. Communication between the display device 630 and other devices is performed by an interface 740 having a communication function and operating under the control of the CPU 710. The display of images by the display portion 631 is performed by the interface 740, which is equipped with a display device, displaying images under the control of the CPU 710. The reception of user operations on the display device 630 is executed by the interface 740, which is equipped with an input device, receiving the user operations.

Any one or more of the above-mentioned programs may be recorded in the non-volatile recording medium 750. In this case, the interface 740 may read the program from the non-volatile recording medium 750. The CPU 710 may then directly execute the program read by the interface 740, or may temporarily store the program in the main storage device 720 or the auxiliary storage device 730 and then execute it.

In addition, a program for executing all or part of the processing performed by learning device 100, learning device 610, display device 620, and display device 630 may be recorded on a computer-readable recording medium, and the program recorded on this recording medium may be read into a computer system and executed to perform the processing of each part. It should be noted that the term “computer system” herein includes an OS (Operating System) and hardware such as peripheral devices.

In addition, the term “computer-readable recording medium” refers to portable media such as flexible disks, optical magnetic disks, ROMs (Read Only Memory), and CD-ROMs (Compact Disc Read Only Memory), as well as storage devices such as hard disks built into computer systems. Furthermore, the above program may be for realizing some of the functions described above, and may further be capable of realizing the functions described above in combination with a program already recorded in the computer system.

Although an embodiment of the present invention has been described in detail above with reference to the drawings, the specific configuration is not limited to this embodiment, and designs of a scope not deviating from the gist of the present invention are also included.

Apart or all of the above-described embodiments can be described as, but is not limited to, the following supplementary notes.

### (Supplementary Note 1)

A learning device comprising:
a model acquisition means that, through training using data that links a state of an environment where an agent performs an action, an action that is executable in the state, and a next state in a case where the action is performed in the state, acquires a model takes a state and an action as input and a next state as output;
a feedback information acquisition means that, based on the acquired model, acquires feedback information that is information that is used for training the model or for training a new model that takes a state and an action as input and a next state as output; and
a policy management means that trains a policy indicating an action of the agent according to a state by using the model acquired through training using the feedback information.

### (Supplementary Note 2)

The learning device according to supplementary note 1,
wherein the feedback information acquisition means acquires the feedback information indicating a constraint condition that should be satisfied by input data and output data of a model to be trained, and the model acquisition means searches for a model using the constraint condition.

### (Supplementary Note 3)

The learning device according to supplementary note 2, further comprising:
an analysis means that calculates, for each item included in information indicating a state, an evaluation index value of accuracy of the item in a next state output by the acquired model,
wherein the feedback information acquisition means acquires the feedback information indicating a constraint condition related to an item having a relatively low evaluation of accuracy.

### (Supplementary Note 4)

The learning device according to supplementary note 3, further comprising:
a display means that displays the evaluation index value; and
an input means that receives a user operation for inputting the feedback information,
wherein the feedback information acquisition means acquires the feedback information input by the user operation accepted by the input means after the display means starts displaying the evaluation index value.

### (Supplementary Note 5)

The learning device according to supplementary note 1,
wherein the feedback information acquisition means acquires the feedback information indicating a correction to the input/output data of the acquired model, and
the model acquisition means trains a model using the input/output data in which the correction is reflected.

### (Supplementary Note 6)

The learning device according to supplementary note 5, further comprising:
an analysis means that calculates, for each of a plurality of time-series data of inputs and outputs of the acquired model, an evaluation index value of accuracy of the time-series data,
wherein the feedback information acquisition means acquires the feedback information indicating a correction to the time-series data having a relatively low evaluation of accuracy.

### (Supplementary Note 7)

The learning device according to supplementary note 6, further comprising:
a display means that displays the evaluation index value; and
an input means that receives a user operation for inputting the feedback information,
wherein the feedback information acquisition means acquires the feedback information input by a user operation accepted by the input means after the display means starts displaying the evaluation index value.

### (Supplementary Note 8)

A display device comprising:
a display means that displays, for each item included in information indicating a next state output by a model simulating an environment in which an agent performs an action in response to input of information indicating a state and information indicating an action, an evaluation index value of accuracy of the item in information indicating the next state.

### (Supplementary Note 9)

A display device comprising:
a display means that displays an evaluation index value of accuracy of each of a plurality of time-series data of a state in an environment and an action of an agent, the plurality of time-series data being time-series data of inputs and outputs of a model simulating an environment in which the agent performs an action.

### (Supplementary Note 10)

A learning method executed by a computer, comprising:
through training using data that links a state of an environment where an agent performs an action, an action that is executable in the state, and a next state in a case where the action is performed in the state, acquiring a model takes a state and an action as input and a next state as output;
based on the acquired model, acquiring feedback information that is information that is used for training the model or for training a new model that takes a state and an action as input and a next state as output; and
training a policy indicating an action of the agent according to a state by using the model acquired through training using the feedback information.

### (Supplementary Note 11)

A display method executed by a computer, comprising:
displaying, for each item included in information indicating a next state output by a model simulating an environment in which an agent performs an action in response to input of information indicating a state and information indicating an action, an evaluation index value of accuracy of the item in information indicating the next state.

### (Supplementary Note 12)

A display method executed by a computer, comprising:
displaying an evaluation index value of accuracy of each of a plurality of time-series data of a state in an environment and an action of an agent, the plurality of time-series data being time-series data of inputs and outputs of a model simulating an environment in which the agent performs an action.

### (Supplementary Note 13)

A recording medium that stores a program for causing a computer to:
through training using data that links a state of an environment where an agent performs an action, an action that is executable in the state, and a next state in a case where the action is performed in the state, acquire a model takes a state and an action as input and a next state as output;
based on the acquired model, acquire feedback information that is information that is used for training the model or for training a new model that takes a state and an action as input and a next state as output; and
train a policy indicating an action of the agent according to a state by using the model acquired through training using the feedback information.

### (Supplementary Note 14)

A recording medium that stores a program for causing a computer to:
display, for each item included in information indicating a next state output by a model simulating an environment in which an agent performs an action in response to input of information indicating a state and information indicating an action, an evaluation index value of accuracy of the item in information indicating the next state.

### (Supplementary Note 15)

A recording medium that stores a program for causing a computer to
display an evaluation index value of accuracy of each of a plurality of time-series data of a state in an environment and an action of an agent, the plurality of time-series data being time-series data of inputs and outputs of a model simulating an environment in which the agent performs an action.

### INDUSTRIAL APPLICABILITY

The present invention may be applied to a learning device, a display device, a learning method, and a recording medium.

### REFERENCE SIGNS LIST

1 Learning system
2 Data collection system
3 Control system
100, 610 Learning device
110 Communication portion
120, 621, 631 Display portion
130 Operation input portion
180 Storage portion
181 Data storage portion
182 Model storage portion
183 Policy storage portion
190 Processing portion
210 Data management portion
220 Learning portion
221 Model management portion
222, 613 Policy management portion
230 Analysis portion
240, 612 Feedback information acquisition portion
300 Data collection device
400 Control device
620, 630 Display device
611 Model acquisition portion

1. A learning device comprising:
a model acquisition means that, through training using data that links a state of an environment where an agent performs an action, an action that is executable in the state, and a next state in a case where the action is performed in the state, acquires a model takes a state and an action as input and a next state as output;
a feedback information acquisition means that, based on the acquired model, acquires feedback information that is information that is used for training the model or for training a new model that takes a state and an action as input and a next state as output; and
a policy management means that trains a policy indicating an action of the agent according to a state by using the model acquired through training using the feedback information.

2. The learning device according to claim 1,
wherein the feedback information acquisition means acquires the feedback information indicating a constraint condition that should be satisfied by input data and output data of a model to be trained, and
the model acquisition means searches for a model using the constraint condition.

3. The learning device according to claim 2, further comprising:
an analysis means that calculates, for each item included in information indicating a state, an evaluation index value of accuracy of the item in a next state output by the acquired model,
wherein the feedback information acquisition means acquires the feedback information indicating a constraint condition related to an item having a relatively low evaluation of accuracy.

4. The learning device according to claim 3, further comprising:
a display means that displays the evaluation index value; and
an input means that receives a user operation for inputting the feedback information,
wherein the feedback information acquisition means acquires the feedback information input by the user operation accepted by the input means after the display means starts displaying the evaluation index value.

5. The learning device according to claim 1,
wherein the feedback information acquisition means acquires the feedback information indicating a correction to the input/output data of the acquired model, and
the model acquisition means trains a model using the input/output data in which the correction is reflected.

6. The learning device according to claim 5, further comprising:
an analysis means that calculates, for each of a plurality of time-series data of inputs and outputs of the acquired model, an evaluation index value of accuracy of the time-series data,
wherein the feedback information acquisition means acquires the feedback information indicating a correction to the time-series data having a relatively low evaluation of accuracy.

7. The learning device according to claim 6, further comprising:
a display means that displays the evaluation index value; and
an input means that receives a user operation for inputting the feedback information,
wherein the feedback information acquisition means acquires the feedback information input by a user operation accepted by the input means after the display means starts displaying the evaluation index value.

8. A display device comprising:
a display means that displays, for each item included in information indicating a next state output by a model simulating an environment in which an agent performs an action in response to input of information indicating a state and information indicating an action, an evaluation index value of accuracy of the item in information indicating the next state.

9. A display device comprising:
a display means that displays an evaluation index value of accuracy of each of a plurality of time-series data of a state in an environment and an action of an agent, the plurality of time-series data being time-series data of inputs and outputs of a model simulating an environment in which the agent performs an action.

10. A learning method executed by a computer, comprising:
through training using data that links a state of an environment where an agent performs an action, an action that is executable in the state, and a next state in a case where the action is performed in the state, acquiring a model takes a state and an action as input and a next state as output;
based on the acquired model, acquiring feedback information that is information that is used for training the model or for training a new model that takes a state and an action as input and a next state as output; and
training a policy indicating an action of the agent according to a state by using the model acquired through training using the feedback information.

11. A display method executed by a computer, comprising:
displaying, for each item included in information indicating a next state output by a model simulating an environment in which an agent performs an action in response to input of information indicating a state and information indicating an action, an evaluation index value of accuracy of the item in information indicating the next state.

12. A display method executed by a computer, comprising:
displaying an evaluation index value of accuracy of each of a plurality of time-series data of a state in an environment and an action of an agent, the plurality of time-series data being time-series data of inputs and outputs of a model simulating an environment in which the agent performs an action.

13. A recording medium that stores a program for causing a computer to:
through training using data that links a state of an environment where an agent performs an action, an action that is executable in the state, and a next state in a case where the action is performed in the state, acquire a model takes a state and an action as input and a next state as output;
based on the acquired model, acquire feedback information that is information that is used for training the model or for training a new model that takes a state and an action as input and a next state as output; and
train a policy indicating an action of the agent according to a state by using the model acquired through training using the feedback information.

14. A recording medium that stores a program for causing a computer to:
display, for each item included in information indicating a next state output by a model simulating an environment in which an agent performs an action in response to input of information indicating a state and information indicating an action, an evaluation index value of accuracy of the item in information indicating the next state.

15. A recording medium that stores a program for causing a computer to
display an evaluation index value of accuracy of each of a plurality of time-series data of a state in an environment and an action of an agent, the plurality of time-series data being time-series data of inputs and outputs of a model simulating an environment in which the agent performs an action.
